(19) United States
(12) Patent Application Publication
(10) Pub. No.: US 2010/0182689 A1
(43) Pub. Date: Jul. 22, 2010

(54) THERMOPLASTIC RESIN COMPOSITION, RESIN MOLDED ARTICLE AND POLARIZER PROTECTIVE FILM EACH USING THE SAME, AND METHOD OF PRODUCING THE RESIN MOLDED ARTICLE

(75) Inventors: Hidetaka Nakanishi, Osaka (JP); Akio Naka, Osaka (JP)

Correspondence Address: HAMRE, SCHUMANN, MUELLER & LARSON, P.C., P.O. BOX 2902, MINNEAPOLIS, MN, 55402-0902, US

(73) Assignee: NIPPON SHOKUBAI CO., LTD., Osaka-shi, Osaka (JP)

(21) Appl. No.: 12/664,167

(22) PCT Filed: Jun. 13, 2008
(86) PCT No.: PCT/JP2008/060884

§ 371 Date: Dec. 11, 2009

(30) Foreign Application Priority Data
Jun. 14, 2007 (JP) 2007-157991
Aug. 1, 2007 (JP) 2007-200689
Aug. 1, 2007 (JP) 2007-200693
Jan. 15, 2008 (JP) 2008-006030

(51) Int. Cl. G02B 1/08; C08L 33/08; C08K 5/3492; C08L 37/00; C08L 39/00

(52) U.S. Cl. 359/485; 524/560; 524/100; 524/548; 524/549

(57) ABSTRACT

Provided is a resin composition containing a thermoplastic acrylic resin and an ultraviolet absorber (UVA). While this resin composition has excellent heat resistance because of its high glass transition temperature, foaming and bleed-out can be suppressed and the problems arising from the evaporation of the UVA can be reduced even during the molding of the resin composition at a high temperature. The resin composition is a thermoplastic resin composition containing a thermoplastic acrylic resin and an ultraviolet absorber having a molecular weight of 700 or more, and having a glass transition temperature of 110° C. or higher. It is preferable that the ultraviolet absorber has a hydroxyphenyltriazine skeleton. It is preferable that the acrylic resin has a ring structure in its main chain. The ring structure is, for example, at least one selected from a lactone ring structure, a glutaric anhydride structure, a glutarimide structure, an N-substituted maleimide structure, and a maleic anhydride structure.

### TECHNICAL FIELD

The present invention relates to a thermoplastic resin composition suitable as a heat-resistant transparent material, as well as a resin molded article made of the resin composition and a polarizer protective film that is a specific example of the resin molded article. The present invention also relates to a polarizing plate including the protective film and an image display apparatus including the polarizing plate, and further relates to a method of producing the resin molded article.

### BACKGROUND ART

Thermoplastic acrylic resins (hereinafter simply referred to as “acrylic resins”) typified by polymethylmethacrylate (PMMA) not only have excellent optical properties such as high light transmittance but also have well-balanced mechanical strength, molding processability, and surface hardness. Therefore, such thermoplastic acrylic resins are used widely as transparent materials for various industrial products such as automobiles and home electric appliances. In recent years, they have been used increasingly in optical-related applications such as optical members used for image display apparatuses.

Acrylic resins sometimes may turn yellow and lose their transparency when they are exposed to light including ultraviolet rays. A known method for preventing such a problem is an addition of an ultraviolet absorber (UVA). If a commonly-used UVA is added, however, foaming may occur or the UVA may bleed out during the molding of an acrylic resin composition containing the UVA. In addition, evaporation of the UVA may occur due to the heat applied during the molding, and as a result, the ultraviolet absorbing ability of the obtained resin molded article may decrease, or a molding machine may be contaminated by the evaporated UVA.

As an acrylic resin having both transparency and heat resistance, a resin having a ring structure in its main chain has been known. A resin having a ring structure in its main chain has a higher glass transition temperature (Tg) than a resin having no ring structure in its main chain, and has various advantages in practical use. For example, a resin having a ring structure in its main chain can be placed easily near a heat generating portion such as a light source in an image display apparatus. JP 2007-31537 A discloses an acrylic resin having an N-substituted maleimide structure as a ring structure in its main chain. JP 2006-328334 A discloses an acrylic resin having a glutarimide structure as a ring structure in its main chain. JP 2000-230016 A and JP 2006-96960 A each disclose an acrylic resin having a lactone ring structure as a ring structure in its main chain. The lactone ring structure can be formed, for example, by a cyclocondensation reaction of a polymer having in its molecule chain a hydroxyl group and an ester group.

As the Tg of a resin or a resin composition increases, the higher molding temperature is required. Therefore, when an UVA is added to an acrylic resin having a ring structure in its main chain, foaming or bleed-out of the UVA occurs easily in the resulting resin molded article. In addition, as the UVA increasingly evaporates during the molding, the ultraviolet absorbing ability decreases and the molding machine is contaminated more easily.

In view of these problems, triazine-based compounds, benzotriazole-based compounds, and benzophenone-based compounds, which are considered to be highly effective in absorbing ultraviolet light even if only a small amount thereof is added, have been used as UVAs in combination with acrylic resins. JP 2006-328334 A mentioned above also discloses these compounds.

These compounds, however, still have a problem of compatibility with an acrylic resin having a ring structure in its main chain. The use of these compounds does not necessarily suppress the occurrence of foaming and bleed-out sufficiently during the molding thereof at a high temperature. When an optical member is formed from a resin composition containing an acrylic resin and a UVA, the resin composition is sometimes filtered through a polymer filter to reduce the defects in the outer appearance of the resulting optical member. In this case, a higher molding temperature is needed to mold the resin composition. As the molding temperature increases, not only do foaming and bleed-out occur more easily, but also various problems arising from the evaporation of the UVA (such as a decrease in the ultraviolet absorbing ability in the resulting resin molded article, and contamination of the molding machine due to the evaporated UVA) occur more easily.

### DISCLOSURE OF THE INVENTION

It is an object of the present invention to provide a resin composition containing an acrylic resin and a UVA. While this resin composition has excellent heat resistance because of its high glass transition temperature, foaming and bleed-out can be suppressed and the problems arising from the evaporation of the UVA can be reduced even during the molding of the resin composition at a high temperature.

The resin composition of the present invention contains a thermoplastic acrylic resin (resin (A)) and an ultraviolet absorber (UVA (B)) having a molecular weight of 700 or more, and has a glass transition temperature of 110° C. or higher.

The resin molded article of the present invention is made of the resin composition of the present invention. The resin molded article of the present invention is, for example, a film or a sheet.

The polarizer protective film of the present invention is one type of the resin molded article of the present invention, and is made of the resin composition of the present invention.

The polarizing plate of the present invention includes a polarizer and the polarizer protective film of the present invention.

The image display apparatus of the present invention includes the polarizing plate of the present invention.

According to the method of producing a resin molded article of the present invention, the resin composition of the present invention is extruded to obtain a molded article.

Not only does the resin composition of the present invention exhibit excellent heat resistance because of its high Tg of 110° C. or higher, but also foaming and bleed-out can be suppressed and the problems arising from the evaporation of the UVA can be reduced even during the molding of the resin composition at a high temperature.

The resin molded article of the present invention made of this resin composition exhibits high heat resistance because of its high Tg, high ultraviolet absorbing ability derived from the UVA (B), and high transparency, mechanical strength and molding processability derived from the resin (A). In addition, the resin molded article of the present invention has few defects in outer appearance or optical properties caused by foaming and bleed-out. This effect is significantly enhanced when the resin molded article of the present invention is a film or a sheet, particularly when it is an optical member such as a polarizer protective film.

### BRIEF DESCRIPTION OF THE DRAWING

FIG. 1 is a schematic diagram showing an example of a structure of an image display portion of an image display apparatus of the present invention.

### BEST MODE FOR CARRYING OUT THE INVENTION

In the following description, “%” and “parts” mean “% by weight” and “parts by weight” respectively, unless otherwise noted.

[Resin Composition]

The resin composition of the present invention is described in detail.

[Resin (A)]

A resin (A) is not particularly limited as long as it is a thermoplastic acrylic resin. The resin (A), however, needs to be an acrylic resin that allows the resulting resin composition to have a Tg of 110° C. or higher.

An acrylic resin is a resin having, as a structural unit, a (meth)acrylic acid ester unit and/or a (meth)acrylic acid unit. It may have a structural unit derived from a derivative of (meth)acrylic acid ester or (meth)acrylic acid. The total content of (meth)acrylic acid ester units, (meth)acrylic acid units, and structural units derived from the above-mentioned derivatives in all the structural units of the acrylic resin usually is at least 50%, preferably at least 60%, and more preferably at least 70%.

Examples of the (meth)acrylic acid ester unit include structural units derived from monomers such as methyl(meth)acrylate, ethyl(meth)acrylate, n-propyl (meth)acrylate, n-butyl(meth)acrylate, t-butyl(meth)acrylate, n-hexyl(meth)acrylate, cyclohexyl(meth)acrylate, benzyl(meth)acrylate, chloromethyl(meth)acrylate, 2-chloroethyl(meth)acrylate, 2-hydroxyethyl(meth)acrylate, 3-hydroxypropyl(meth)acrylate, 2,3,4,5,6-pentahydroxyhexyl(meth)acrylate, 2,3,4,5-tetrahydroxypentyl(meth)acrylate, methyl 2-(hydroxymethyl)acrylate, and methyl 2-(hydroxyethyl)acrylate. The resin (A) may have two or more types of these structural units as (meth)acrylic acid ester units. Preferably, the resin (A) has a methyl(meth)acrylate unit. In this case, the thermal stability of the resin (A), a resin composition containing the resin (A), and a resin molded article obtained by molding the resin composition is enhanced.

The Tg of the resin (A) usually is 100° C. or higher because the Tg of the resin composition, which further contains the UVA (B), is 100° C. or higher. The Tg of the resin (A) is preferably 115° C. or higher, more preferably 120° C. or higher, and still more preferably 130° C. or higher. In these cases, the Tg of the resin composition increases. The Tg of polymethylmethacrylate (PMMA), which is a typical acrylic resin, is 105° C.

The resin (A) may have a ring structure in its main chain. In this case, the Tg of the resin (A) and the resin composition increases, and thereby the heat resistance of a resin molded article obtained from the resin composition is improved. A resin molded article, for example, a resin film, obtained from the resin composition containing the resin (A) having a ring structure in its main chain is used suitably as an optical member because it can be placed easily near a heat generating portion such as a light source in an image display apparatus.

When the Tg of the resin composition is increased because the resin (A) has a ring structure, the molding temperature thereof also needs to be increased accordingly (an acrylic resin composition usually is formed into a molded article by extrusion molding, and in this molding, the resin composition needs to be extruded at a temperature equal to or higher than the Tg thereof). As the molding temperature increases, foaming and bleed-out of a UVA occurs easily during molding, and the UVA also evaporates more easily. Even in such a case, the resin composition of the present invention is resistant to foaming and bleed-out, and can reduce the problems arising from the evaporation of the UVA.

The type of the ring structure is not particularly limited. For example, the ring structure is at least one selected from a lactone ring structure, a glutaric anhydride structure, a glutarimide structure, an N-substituted maleimide structure, and a maleic anhydride structure.

It is preferable that the ring structure is at least one selected from a glutarimide structure, a glutaric anhydride structure, and a lactone ring structure. In this case, the Tg of the resin (A) and the Tg of the resin composition increase. It is preferable that the ring structure is a lactone ring structure because it does not contain a nitrogen atom in its structure and therefore is less colored (yellowed) and has excellent optical properties as a resin molded article. That is, it is preferable that the resin (A) is an acrylic resin having a lactone ring structure in its main chain.

The following chemical formula (2) shows a glutarimide structure and a glutaric anhydride structure.

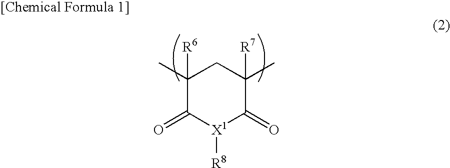

In the above formula (2), R⁶ and R⁷ each independently represent a hydrogen atom or a methyl group, and X¹ is an oxygen atom or a nitrogen atom. When X¹ is an oxygen atom, R⁸ is not present. When X¹ is a nitrogen atom, R⁸ is a hydrogen atom, a straight-chain alkyl group having 1 to 6 carbon atoms, a cyclopentyl group, a cyclohexyl group, or a phenyl group.

When X¹ is a nitrogen atom, the ring structure represented by the formula (2) is a glutarimide structure. The glutarimide structure can be formed, for example, by imidizing a (meth)acrylic acid ester polymer with an imidizing agent such as methylamine.

When X¹ is an oxygen atom, the ring structure represented by the formula (2) is a glutaric anhydride structure. The glutaric anhydride structure can be formed, for example, by intra-molecule dealcoholization and cyclocondensation of a copolymer of (meth)acrylic acid ester and (meth)acrylic acid.

The following formula (3) shows an N-substituted maleimide structure and a maleic anhydride structure.

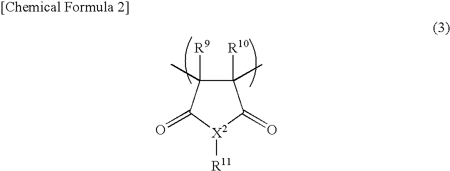

In the above formula (3), R⁹ and R¹⁰ each independently represent a hydrogen atom or a methyl group, and X² is an oxygen atom or a nitrogen atom. When X² is an oxygen atom, R¹¹ is not present. When X² is a nitrogen atom, R¹¹ is a hydrogen atom, a straight-chain alkyl group having 1 to 6 carbon atoms, a cyclopentyl group, a cyclohexyl group, or a phenyl group.

When X² is a nitrogen atom, the ring structure represented by the formula (3) is an N-substituted maleimide structure. An acrylic resin having an N-substituted maleimide structure in its main chain can be formed, for example, by copolymerizing N-substituted maleimide and (meth)acrylic acid ester.

When X² is an oxygen atom, the ring structure represented by the formula (3) is a maleic anhydride structure. An acrylic resin having a maleic anhydride structure in its main chain can be formed, for example, by copolymerizing maleic anhydride and (meth)acrylic acid ester.

In the above-mentioned methods of forming the ring structures as examples for explaining the formulas (2) and (3), all the polymers used for forming the respective ring structures each have a (meth)acrylic acid ester unit as a structural unit. Therefore, the resins obtained by these methods are acrylic resins.

There is no particular limitation on the lactone ring structure that the resin (A) may have in its main chain. For example, it may be a 4-membered to 8-membered ring structure. Preferably, it is a 5-membered or 6-membered ring structure because it is excellent in stability as a ring structure, and more preferably it is a 6-membered ring structure. A 6-membered lactone ring structure is, for example, a structure disclosed in JP 2004-168882 A. It is preferable that the ring structure has a structure represented by the following formula (4) for the following reasons: a precursor has a high polymerization yield (the resin (A) having a lactone ring structure in its main chain can be obtained by subjecting the precursor to cyclocondensation reaction); the resin (A) having a high content of the lactone ring structure can be obtained by the cyclocondensation reaction of the precursor; and a polymer having a methyl methacrylate unit as a structural unit can be used as the precursor.

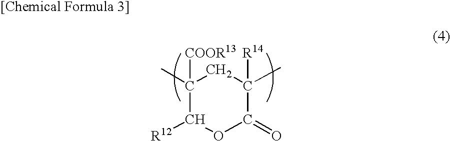

In the above formula (4), R¹², R¹³ and R¹⁴ each independently represent a hydrogen atom, or an organic residue having 1 to 20 carbon atoms. The organic residue may contain an oxygen atom.

Examples of the organic residue in the formula (4) include: alkyl groups having 1 to 20 carbon atoms such as a methyl group, an ethyl group, a propyl group; unsaturated aliphatic hydrocarbon groups having 1 to 20 carbon atoms such as an ethenyl group and a propenyl group; aromatic hydrocarbon groups having 1 to 20 carbon atoms such as a phenyl group and a naphthyl group; groups obtained by substituting one or more hydrogen atoms of the above-mentioned alkyl groups, the above-mentioned unsaturated aliphatic hydrocarbon groups, and the above-mentioned aromatic hydrocarbon groups with at least one selected from a hydroxyl group, a carboxyl group, an ether group, and an ester group.

The content of the above-mentioned ring structure (except for the lactone ring structure) in the resin (A) is not particular limited. For example, the content is 5 to 90%. Preferably, it is 10 to 70%, more preferably 10 to 60%, and still more preferably 10 to 50%.

In the case where the resin (A) has a lactone ring structure in its main chain, the content of the lactone ring structure in this resin is not particularly limited. For example, the content is 5 to 90%. It is more preferable as the range of the content is narrowed to 20 to 90%, 30 to 90%, 35 to 90%, 40 to 80%, and further 45 to 75%.

If the content of the ring structure in the resin (A) is excessively low, the heat resistance of the resin composition and the resin molded article obtained by molding the resin composition may decrease, or the solvent resistance and the surface hardness thereof may become insufficient. On the other hand, if the content of the ring structure is excessively high, the molding processability and ease of handling of the resin composition are degraded.

The resin (A) having a ring structure in its main chain can be produced by a known method. The resin (A) having a lactone ring structure can be produced by the method described, for example, in JP 2006-96960 A (WO 2006/025445), JP 2006-171464 A, or JP 2007-63541 A. The resin (A) having an N-substituted maleimide structure, a glutaric anhydride structure, or a glutarimide structure can be produced by the method described, for example, in JP 2007-31537 A, WO 2007/26659, or WO 2005/108438. The resin (A) having a maleic anhydride structure can be produced by the method described, for example, in JP 57(1982)-153008 A.

The resin (A) may have a structural unit other than a (meth)acrylic acid ester unit and a (meth)acrylic acid unit. Such structural units are structural units derived from monomers such as styrene, vinyl toluene, α-methylstyrene, acrylonitrile, methyl vinyl ketone, ethylene, propylene, vinyl acetate, methallyl alcohol, allyl alcohol, 2-hydroxymethyl-1-butene, α-hydroxymethyl styrene, α-hydroxyethyl styrene, 2-(hydroxyalkyl)acrylic acid ester such as methyl 2-(hydroxyethyl)acrylate, 2-(hydroxyalkyl)acrylic acid such as 2-(hydroxyethyl)acrylic acid. The resin (A) may have two or more types of these structural units.

The resin (A) may have a structural unit having an effect of allowing the resin itself to have a negative intrinsic birefringence. In this case, the degree of freedom in controlling the birefringent properties of the resin composition and the resin molded article obtained by molding the resin composition is improved, and thereby a range of applications of the resin molded article (for example, a resin film) formed from the resin composition of the present invention, as an optical member, is expanded.

An “intrinsic birefringence” is a value (n1−n2) obtained by subtracting a refractive index n2 from a refractive index n1 in a layer (for example, a sheet or a film) in which a molecular chain of a resin is oriented uniaxially. The n1 is a refractive index of light traveling in the direction parallel to the direction (orientation axis) in which the molecular chain is oriented. The n2 is a refractive index of light traveling in the direction perpendicular to the orientation axis. Whether the intrinsic birefringence of the resin (A) itself is positive or negative is determined in view of the balance between the effect of the target structural unit on the intrinsic birefringence and the effect of the other structural units of the resin (A).

An example of the structural unit having an effect of allowing the resin (A) to have a negative intrinsic birefringence is a styrene unit.

The resin (A) may have a structural unit (UVA unit) having an ultraviolet absorbing ability. In this case, the ultraviolet absorbing ability of the resin composition and the resin molded article obtained by molding the resin composition is improved further. The compatibility between the resin (A) and the UVA (B) is improved depending on the structure of the UVA unit.

The monomer (C) as a source of the UVA unit is not particularly limited. For example, the monomer (C) is a benzotriazole derivative, a triazine derivative, or a benzophenone derivative, into which a polymerizable group is introduced. The polymerizable group to be introduced can be selected suitably according to the structural unit included in the resin (A).

Specific examples of the monomer (C) include
2-(2′-hydroxy-5′-methacryloyloxy)ethylphenyl-2H-benzotriazole (trade name: RUVA-93, manufactured by Otsuka Chemical Co., Ltd.), 2-(2′-hydroxy-5′-methacryloyloxy)phenyl-2H-benzotriazole, and 2-(2′-hydroxy-3′-t-butyl-5′-methacryloyloxy)phenyl-2H-benzotriazole.

Another specific example of the monomer (C) is a triazine derivative represented by the following formulas (5), (6), or (7), or a benzotriazole derivative represented by the following formula (8).

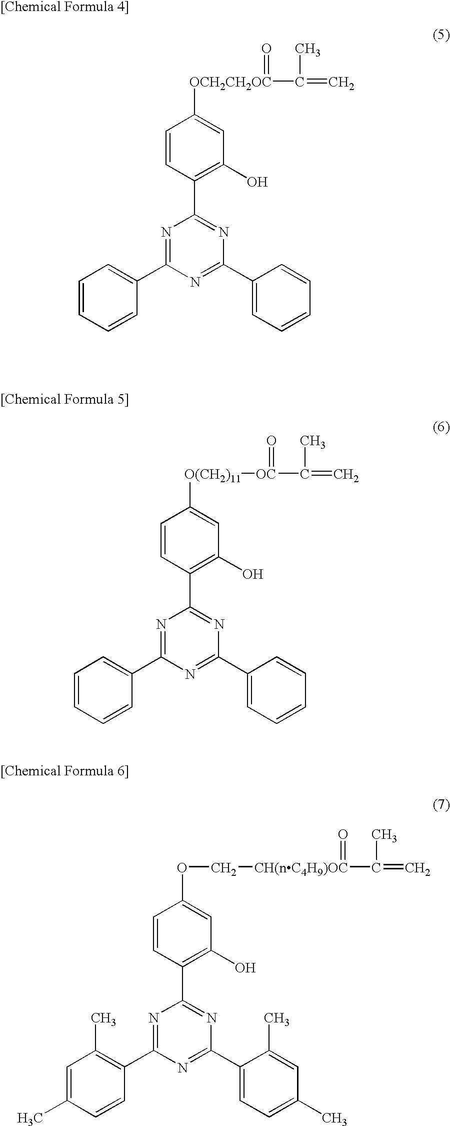

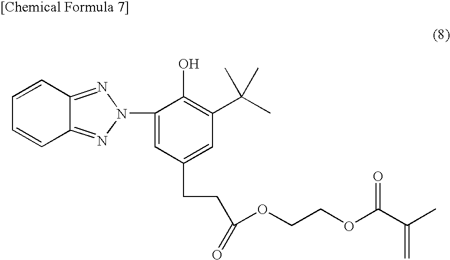

It is preferable that the monomer (C) is 2-(2′-hydroxy-5′-methacryloyloxy)ethylphenyl-2H-benzotriazole because of its high ultraviolet absorbing ability. If the resin (A) contains a UVA unit having high ultraviolet absorbing ability, a desired ultraviolet absorbing effect can be obtained even if the resin (A) has a low content of the UVA unit. In other words, when the resin (A) contains a UVA unit, the content of the structural units other than the UVA unit can be increased relatively. Therefore, a resin composition having properties (for example, thermoplasticity and heat resistance) suitable for various applications such as an optical member can be obtained easily. Further, if the resin has a high content of the UVA unit, the resin composition is colored easily during the molding thereof. Therefore, if the resin (A) contains a UVA unit having a high ultraviolet absorbing ability, coloring of the resin molded article as an end product can be suppressed, and thereby the resin molded article can be used suitably as an optical member.

In the case where the resin (A) contains a UVA unit, the content of the UVA unit in the resin (A) is preferably 20% or less, and more preferably 15% or less. If the content of the UVA unit in the resin (A) exceeds 20%, the heat resistance of the resin composition decreases.

The resin (A) has a weight average molecular weight of 1000 to 300000, for example. Preferably, the weight average molecular weight is 5000 to 250000, more preferably 10000 to 200000, and still more preferably 50000 to 200000.

[UVA(B)]

The UVA (B) has a molecular weight of 700 or more. Preferably, the molecular weight is 800 or more, and more preferably 900 or more. On the other hand, when the molecular weight exceeds 10000, the compatibility with the resin (A) decreases, and thereby, the optical properties, such as a hue and a haze, of the resin molded article as an end product are degraded. The upper limit of the molecular weight of the UVA (B) is preferably 8000 or less, and more preferably 5000 or less.

It is preferable that the UVA (B) does not contain a repeating unit derived from a monomer (that is, the UVA (B) is not a polymer). In the case where the UVA (B) contains a repeating unit derived from a monomer, a polymerization initiator or a chain transfer agent that remains in the UVA causes the resin composition to be colored easily during the molding thereof.

The UVA (B) may be a mixture of two or more compounds as long as the compound as a main component has a molecular weight of 700 or more. In the present specification, a main component means a component whose content (in terms of percentage) is the highest, and the content thereof typically is at least 50%.

The UVA (B) may be a solid or a liquid at room temperature. Preferably, the UVA (B) is a liquid at room temperature because the sublimation of a solid UVA during molding easily could cause problems.

It is preferable that the molar absorption coefficient of the UVA (B) in a chloroform solution is 10000 (L·mol⁻¹·cm⁻¹) or more at the maximum absorption wavelength of light having wavelengths in a range of 300 nm to 380 nm.

The structure of the UVA (B) is not particularly limited as long as it has a molecular weight of 700 or more, and it is preferable that the UVA (B) has a hydroxyphenyltriazine skeleton. A hydroxyphenyltriazine skeleton is a skeleton ((2-hydroxyphenyl)-1,3,5-triazine skeleton) composed of triazine and three hydroxyphenyl groups bonded to the triazine. A hydrogen atom of a hydroxyl group in a hydroxyphenyl group forms a hydrogen bond with a nitrogen atom of triazine. The hydrogen bond thus formed enhances the effect of phenyltriazine as a chromophore. Since three hydrogen bonds are formed in the UVA (B), the effect of phenyltriazine as a chromophore further can be increased, and thereby, high ultraviolet absorbing ability can be obtained with a small amount of UVA (B) added. In the case where the UVA (B) is composed of a mixture of two or more compounds, it is preferable that at least the compound as a main component has a hydroxyphenyltriazine skeleton.

A substituent group such as an alkyl group and an alkyl ester group may be bonded to the hydroxyphenyl group in the hydroxyphenyltriazine skeleton, but it is preferable that the substituent group does not have a structure that can be a crosslinking point with the resin (A). The structure that can be a crosslinking point is, for example, a functional group such as a hydroxyl group, a thiol group, or an amine group, or a double bond thereof.

The resin composition of the present invention contains the thermoplastic acrylic resin (A) and the UVA (B), and the Tg of the resin composition is 110° C. or higher, which requires a high temperature for molding (for example, for extrusion molding). Accordingly, a gel may be formed during the molding thereof. As the molding temperature increases, a gel is formed more easily. That is, when the Tg of the resin composition is high, for example, in the case where the resin (A) has a ring structure in its main chain, a high molding temperature is required and therefore a gel is formed more easily.

If a structure that can be a crosslinking point with the resin (A) is present in the substituent group of the hydroxyphenyl group in the hydroxyphenyltriazine skeleton, a risk that a gel may be formed in the resin composition during the molding thereof increases. In other words, if the UVA (B) does not have a structure that can be a crosslinking point with the resin (A) in its substituent group, gel formation can be prevented during the molding of the resin composition, and thereby a resin film (for example, a polarizer protective film) having few optical defects can be obtained. Further, since the molding temperature of the resin composition can be raised further by preventing the gel formation, the following effects can be obtained: (1) the melt viscosity of the composition during the molding decreases, and thereby the productivity of the resin molded article is improved; and (2) in the case where filtration is performed with a polymer filter during the molding in order to remove foreign substances such as gels, the formation of such gels is prevented, and thereby the replacement cycle of the filter is extended.

A hydroxyl group as a substituent group is present in a hydroxyphenyl group. However, since a hydroxyl group directly bonded to a benzene ring does not form a crosslinked structure with the resin (A), the hydroxyphenyl group is not regarded as a structure that can be a crosslinking point with the resin (A).

Triacetyl cellulose (TAC) is one of the materials to be used as optical members. Since TAC decomposes at a low temperature of about 250° C., it cannot be molded by extrusion and usually is formed into a film by a casting method. Specifically, since TAC itself is not exposed to high temperature during the formation of a TAC film, whether or not a structure that can be a crosslinking point with TAC is present in UVA does not adversely affect the frequency of occurrence of optical defects in TAC films and the productivity thereof.

The UVA (B) has, for example, a structure represented by the following formula (1). The UVA (B) having the structure represented by the following formula (1) is excellent in compatibility with the acrylic resin (A), especially the acrylic resin (A) having a ring structure in its main chain, and also has a high ultraviolet absorbing ability.

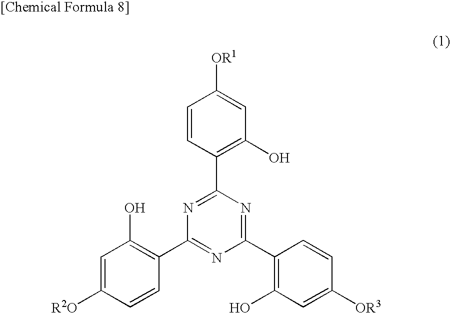

In the above formula (1), R¹ to R³ each independently represent a hydrogen atom, or an alkyl group or an alkyl ester group each having 1 to 18 carbon atoms. It is preferable that the alkyl ester group is a group represented by a formula “—CH(—R⁴)C(═O)OR⁵”, where R⁴ is a hydrogen atom or a methyl group, and R⁵ is an alkyl group having a straight chain or a branched chain. In the case where R¹ to

R³ are alkyl groups, they may be either straight-chain alkyl groups or branched-chain alkyl groups.

Preferably, R¹ to R³ are alkyl ester groups because they improve the compatibility with the resin (A).

Specific examples of the UVA (B) having the structure represented by the above formula (1) include those represented by the following formulas (9) and (10). The UVA (B) is not limited to the following examples.

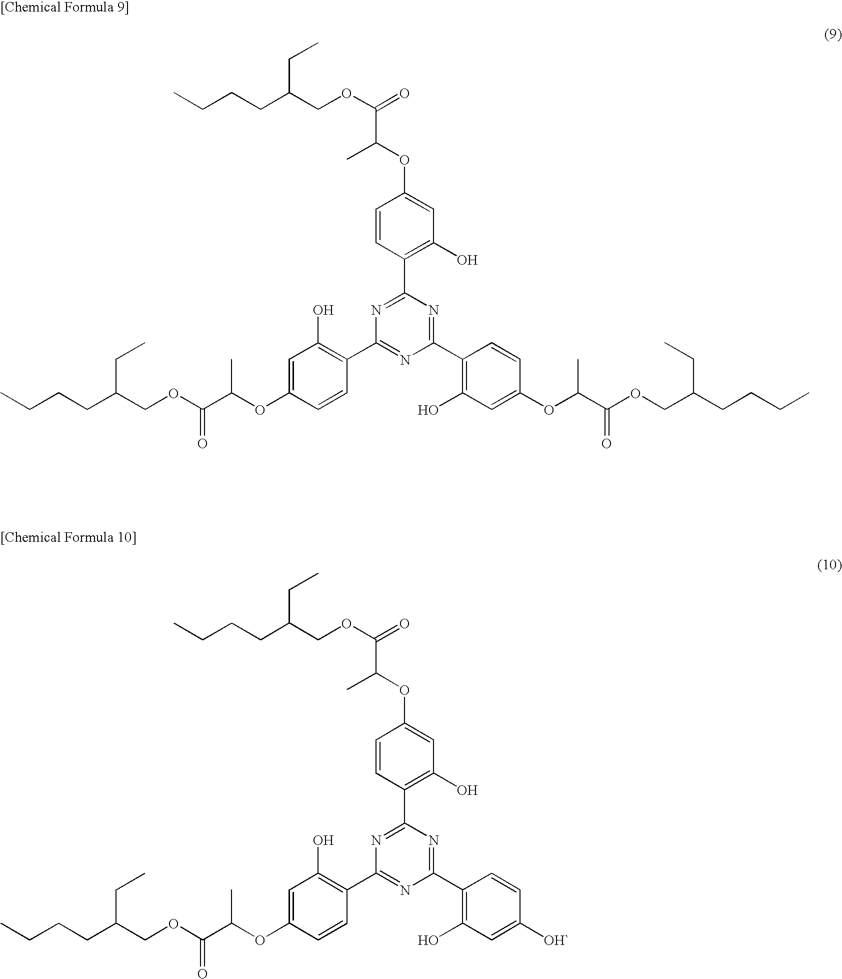

Examples of commercially available ultraviolet absorbers that contain as a main component the UVA (B) represented by the above formula (9) and as a sub-component the UVA (B) represented by the above formula (10) include CGL 777MPA (manufactured by Ciba Speciality Chemicals Inc.) and CGL 777MPAD (manufactured by Ciba Speciality Chemicals Inc.).

[Resin Composition]

The content of the UVA (B) in the resin composition of the present invention is not particularly limited, and for example, it is 0.1 to 5 parts with respect to 100 parts of thermoplastic resins including the resin (A). When the content of the UVA (B) is excessively low, sufficient ultraviolet absorbing ability cannot be obtained. On the other hand, when the content of the UVA (B) is excessively high, disadvantages such as foaming and bleed-out that occur during the molding exceed advantages of improved ultraviolet ability.

Preferably, the content of the UVA (B) in the resin composition of the present invention is 0.5 to 5 parts with respect to 100 parts of thermoplastic resins, and it is more preferable as the range of the content is narrowed to 0.7 to 3 parts, 1 to 3 parts, and further 1 to 2 parts.

The main component of the thermoplastic resins contained in the resin composition of the present invention is the resin (A). Specifically, the percentage of the resin (A) among all the thermoplastic resins contained in the resin composition of the present invention usually is at least 60%, preferably at least 70%, and more preferably at least 85%. In other words, the resin composition of the present invention may contain at least one thermoplastic resin other than the resin (A) within a range of less than 40% (preferably less than 30%, and more preferably less than 15%) of the total amount of thermoplastic resins contained in the resin composition.

Examples of the at least one other thermoplastic resin include: olefin polymers such as polyethylene, polypropylene, an ethylene-propylene copolymer, poly(4-methyl-1-pentene); halogen-containing polymers such as vinyl chloride and chlorinated vinyl resin; styrene polymers such as polystyrene, a styrene-methyl methacrylate copolymer, a styrene-acrylonitrile copolymer, and an acrylonitrile-butadiene-styrene block copolymer; polyesters such as polyethylene terephthalate, polybutylene terephthalate, and polyethylene naphthalate; polyamides such as nylon 6, nylon 66, and nylon 610; polyacetal; polycarbonate; polyphenylene oxide; polyphenylene sulfide; polyetheretherketone; polysulfone;

polyether sulfone; polyoxybenzylene; polyamidoimide; and rubber polymers such as ABS resin and ASA resin including a polybutadiene rubber or an acrylic rubber. It is preferable that the rubber polymer has, on its surface, a graft portion having a composition compatible with the resin (A). In the case where the rubber polymer is in the form of particles, it is preferable that the average particle diameter is 300 nm or less, and more preferably 150 nm or less, in view of improvement in transparency of a resin film obtained from the resin composition of the present invention.

Among the thermoplastic resins as shown above, a copolymer containing a structural unit derived from a cyanated vinyl monomer and a structural unit derived from an aromatic vinyl monomer is used preferably because it is excellent in compatibility with the resin (A), especially with the resin (A) having a lactone ring structure in its main chain. Examples of such a copolymer include a styrene-acrylonitrile copolymer, and a polyvinyl chloride resin.

The resin composition of the present invention has a high glass transition temperature (Tg) of 110° C. or higher. The Tg of the resin composition of the present invention is 115° C. or higher, 120° C. or higher, or 130° C. or higher in some cases depending on the structure of the resin (A) (for example, whether or not the resin (A) h_{as a r}in_{g} structure in its main chain, or if the resin (A) has a ring structure in its main chain, the percentage of the content of the ring structure, etc.). In the present specification, Tg is defined as a temperature determined by a starting point method according to JIS K7121 using a differential scanning calorimeter (DSC).

The resin composition of the present invention has an ultraviolet absorbing ability derived from the UVA (B). For example, in the case where the resin composition is molded into a film having a thickness of 100 μm, the film can have a light transmittance of less than 30% at a wavelength of 380 nm. The film further can have the light transmittance of less than 20%, less than 10%, or less than 1% in some cases. This light transmittance can be measured according to JIS K7361: 1997.

The resin composition of the present invention has a high visible light transmittance because of the compatibility between the resin (A) and the UVA (B). For example, in the case where the resin composition is molded into a film having a thickness of 100 μm, the film can have a light transmittance of 80% or more at a wavelength of 500 nm. The film further can have the light transmittance of 85% or more, or 90% or more in some cases. This light transmittance can be measured in the same manner as the light transmittance at a wavelength of 380 nm.

In the resin composition of the present invention, the sublimation of the UVA (B) can be suppressed during and after the molding of the composition. For example, a light absorbance measured in the following manner can be less than 0.05 at a wavelength of 350 nm, as described later in Examples. First, a film being made of the resin composition and having predetermined dimensions is heated at 150° C. for 10 hours to obtain a volatile component of the film. Next, the volatile component is dissolved in a solvent (for example, chloroform) of 1 ml volume to obtain a solution. Then, the resulting solution is placed in a quartz cell with an optical path length of 1 cm and the light absorbance of the solution is measured with an absorption spectrometer. As the amount of sublimed UVA increases, the amount of UVA in the volatile component increases, and as a result, the light absorbance of the solution obtained by dissolving the volatile component also increases.

In the resin composition of the present invention, a combined use of the above-mentioned resin (A) and UVA (B) improves the hue of the resin composition itself and the resin molded article obtained by molding the resin composition.

The resin composition of the present invention is less colored during the molding thereof. For example, in the case where the resin composition is molded into a film having a thickness of 100 μm, the film can have a b value of 3.0 or less, or 2.0 or less in some cases in the Lab color system (Hunter color system) thereof. Many of conventional acrylic resin compositions having ultraviolet absorbing ability are colored (yellowed) during the molding process. In the resin composition of the present invention, however, such coloring can be suppressed.

The resin composition of the present invention has excellent thermal stability. The resin composition can have a 5% weight loss temperature of 280° C. or higher evaluated by thermogravimetric analysis (TG). The resin composition can have a 5% weight loss temperature of 290° C. or higher, or 300° C. or higher in some cases.

In the resin composition of the present invention, the total content of components having boiling points equal to or lower than the Tg of the resin composition is preferably 5000 ppm or less, and more preferably 3000 ppm or less. When the total content of the above components exceeds 5000 ppm, the resin composition may be colored during the molding thereof, or molding defects such as silver streaks may occur.

The resin composition of the present invention may contain a polymer having a negative intrinsic birefringence. In this case, the degree of freedom in controlling the birefringent properties (for example, a retardation) of the resin composition and the resin molded article obtained by molding the resin composition is improved.

The polymer having a negative intrinsic birefringence is, for example, a copolymer of a cyanated vinyl monomer and an aromatic vinyl monomer. This copolymer is, for example, a styrene-acrylonitrile copolymer. A styrene-acrylonitrile copolymer has excellent compatibility with the resin (A) in a wide range of copolymerization compositions.

A styrene-acrylonitrile copolymer can be produced by various polymerization methods such as emulsion polymerization, suspension polymerization, solution polymerization, and bulk polymerization. When the resin molded article formed from the resin composition of the present invention is used as an optical member, it is preferable to use a styrene-acrylonitrile copolymer produced by solution polymerization or bulk polymerization. In this case, the transparency and optical properties of the resulting resin molded article are improved.

The resin composition of the present invention may contain an antioxidant. The antioxidant is not particularly limited. For example, a known antioxidant such as a hindered phenol-based antioxidant, or a phosphor- or sulfur-based antioxidant can be used. Two or more of these antioxidants also can be used in combination. It is particularly preferable to use 2,4-di-tert-amyl-6-[1-(3,5-di-tert-amyl-2-hydroxyphenyl)ethyl]phenyl acrylate (for example, Sumilizer GS, manufactured by Sumitomo Chemical Industry Co., Ltd.), and 2-tert-butyl-6-(3-tert-butyl-2-hydroxy-5-methylbenzyl)-4-methylphenyl acrylate (for example, Sumilizer GM, manufactured by Sumitomo Chemical Industry Co., Ltd.) because they are highly effective in suppressing the deterioration of the resin composition during the high-temperature molding thereof.

The antioxidant may be a phenol-based antioxidant. Examples of the phenol-based antioxidant include
n-octadecyl-3-(3,5-di-tert-butyl-4-hydroxyphenyl)propionate, n-octadecyl-3-(3,5-di-tert-butyl-4-hydroxyphenyl)acetate, n-octadecyl-3,5-di-tert-butyl-4-hydroxybenzoate, n-hexyl-3,5-di-tert-butyl-4-hydroxyphenylbenzoate, n-dodecyl-3,5-di-tert-butyl-4-hydroxyphenylbenzoate, neo-dodecyl-3-(3,5-di-tert-butyl-4-hydroxyphenyl)propionate, dodecyl-β-(3,5-di-tert-butyl-4-hydroxyphenyl)propionate, ethyl-α-(4-hydroxy-3,5-di-tert-butylphenyl)isobutyrate, octadecyl-α-(4-hydroxy-3,5-di-tert-butylphenyl)isobutyrate, octadecyl-α-(4-hydroxy-3,5-di-tert-butyl-4-hydroxyphenyl)propionate, 2-(n-octylthio)ethyl-3,5-di-tert-butyl-4-hydroxy-benzoate, 2-(n-octylthio)ethyl-3,5-di-tert-butyl-4-hydroxy-phenylacetate, 2-(n-octadecylthio)ethyl-3,5-di-tert-butyl-4-hydroxyphenylacetate, 2-(n-octadecylthio)ethyl-3,5-di-tert-butyl-4-hydroxybenzoate, 2-(2-hydroxyethylthio)ethyl-3,5-di-tert-butyl-4-hydroxybenzoate, diethylglycol-bis-(3,5-di-tert-butyl-4-hydroxy-phenyl)propionate, 2-(n-octadecylthio)ethyl-3-(3,5-di-tert-butyl-4-hydroxyphenyl)propionate, stearamide-N,N-bis-[ethylene-3-(3,5-di-tert-butyl-4-hydroxyphenyl)propionate], N-butylimino-N,N-bis-[ethylene-3-(3,5-di-tert-butyl-4-hydroxyphenyl)propionate], 2-(2-stearoyloxyethylthio)ethyl-3,5-di-tert-butyl-4-hydroxybenzoate, 2-(2-stearoyloxyethylthio)ethyl-7-(3-methyl-5-tert-butyl-4-hydroxyphenyl)heptanoate, 1,2-propyleneglycol-bis-[3-(3,5-di-tert-butyl-4-hydroxyphenyl)propionate], ethyleneglycol-bis-[3-(3,5-di-tert-butyl-4-hydroxyphenyl)propionate], neopentylglycol-bis-[3-(3,5-di-tert-butyl-4-hydroxyphenyl)propionate], ethyleneglycol-bis-(3,5-di-tert-butyl-4-hydroxyphenylacetate), glycerine-1-n-octadecanoate-2,3-bis-(3,5-di-tert-butyl-4-hydroxyphenylacetate), pentaerythritol-tetrakis-[3-(3′,5′-di-tert-butyl-4′-hydroxyphenyl)propionate], 1,1,1-trimethylolethane-tris-[3-(3,5-di-tert-butyl-4-hydroxyphenyl)propionate], sorbitol hexa-[3-(3,5-di-tert-butyl-4-hydroxyphenyl)propionate], 2-hydroxyethyl-7-(3-methyl-5-tert-butyl-4-hydroxyphenyl)propionate, 2-stearoyloxyethyl-7-(3-methyl-5-tert-butyl-4-hydroxyphenyl)propionate], 1,6-n-hexanediol-bis-[(3′,5′-di-tert-butyl-4-hydroxyphenyl)propionate), and pentaerythritol-tetrakis(3,5-di-tert-butyl-4-hydroxyhydrocinnamate), and 3,9-bis[1,1-dimethyl-2-[β-(3-tert-butyl-4-hydroxy-5-methylphenyl)propionyloxy]ethyl]2,4,8,10-tetraoxaspiro[5,5]-undecane.

It is preferable to use a phenol-based antioxidant in combination with a thioether-based antioxidant or a phosphor-based antioxidant. When the antioxidants are used in combination, the amounts thereof to be added are, for example, 0.01 parts or more of a phenol-based antioxidant and 0.01 parts or more of a thioether-based antioxidant, respectively, with respect to 100 parts of the resin (A), or 0.025 parts or more of a phenol-based antioxidant and 0.025 parts or more of a phosphor-based antioxidant, respectively, with respect to 100 parts of the resin (A).

Examples of thioether-based antioxidants include pentaerythrityl tetrakis(3-laurylthiopropionate), dilauryl-3,3′-thiodipropionate, dimyristyl-3,3′-thiodipropionate, and distearyl-3,3′-thiodipropionate.

Examples of phosphor-based antioxidants include tris(2,4-di-tert-butylphenyl)phosphate, 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamin, diphenyltridecylphosphite, triphenylphosphite, 2,2-methylenebis(4,6-di-tert-butylphenyl)octyl phosphite, bis(2,6-di-tert-butyl-4-methylphenyl)pentaerythritol diphosphite, distearyl pentaerythritol disphosphite, and cyclic neopentanetetrailbis (2,6-di-tert-butyl-4-methylphenyl)phosphite.

The amount of the antioxidant to be contained in the resin composition of the present invention is, for example 0 to 10%. It is preferably 0 to 5%, more preferably 0.01 to 2%, and still more preferably 0.05 to 1%. When an excessively large amount of the antioxidant is contained, the antioxidant may bleed out or silver streaks may be formed during the molding thereof.

The resin composition of the present invention may contain other additives. Examples of the other additives include: stabilizers such as a light stabilizer, a weathering stabilizer, and a thermal stabilizer; reinforcers such as glass fiber and carbon fiber; near-infrared absorbers; flame retardants such as tris(dibromopropyl)phosphate, triallylphosphate, and antimony oxide; antistatic agents such as anionic, cationic, or nonionic surfactants; coloring agents such as an inorganic pigment, an organic pigment, and a dye; organic fillers and inorganic fillers; resin modifiers; plasticizers; lubricants; and flame retardants. The content of the other additives in the resin composition of the present invention is, for example, 0 to 5%. It is preferably 0 to 2%, and more preferably 0 to 0.5%.

The resin composition of the present invention can be molded into an arbitrary shape, for example, a film or a sheet, by a known molding technique such as injection molding, blow molding, extrusion molding, or cast molding. The molding temperature can be set suitably according to the Tg and properties of the resin composition and is not particularly limited. For example, the molding temperature is 150 to 350° C., and it is preferably 200 to 300° C.

The resin molded article obtained by molding the resin composition of the present invention has few defects such as foaming and bleed-out, and has high ultraviolet absorbing ability, heat resistance, and transparency.

[Production Method of Resin Composition]

The resin composition of the present invention can be produced by mixing a thermoplastic resin containing the resin (A) as a main component and the UVA (B) by a known method. The resin composition thus produced may be pelletized by a pelletizer or the like.

The timing of mixing the thermoplastic resin and the UVA (B) is not particular limited as long as the above-mentioned various properties of the resin composition are not impaired. The UVA (B) may be added during the polymerization of the thermoplastic resin (for example, the resin (A)). The resulting thermoplastic resin and the UVA (B) may be mixed (for example, melt-kneaded) after the polymerization of the thermoplastic resin. The technique for melt-kneading the thermoplastic resin and the UVA (B) is not particularly limited to a specific one. For example, the thermoplastic resin, the UVA (B), and other additives may be melted by heating and kneaded at the same time. After the thermoplastic resin and the other additives are melted by heating, the UVA (B) may be added into the melted mixture to knead the resulting mixture. After the thermoplastic resin is melted by heating, the UVA (B) and the other additives may be added into the melted resin to knead the resulting mixture.

[Resin Molded Article]

The resin molded article of the present invention is made of the above-mentioned resin composition of the present invention. The resin molded article of the present invention has various properties derived from the above-mentioned properties of the resin composition of the present invention. For example, the resin molded article of the present invention has high ultraviolet absorbing ability, heat resistance, and transparency. The resin molded article of the present invention has few defects such as foaming and bleed-out.

Because of these features, the resin molded article of the present invention can be used suitably as an optical member. The resin molded article of the present invention can be placed near a heat generating portion such as a light source because of its high heat resistance.

The shape of the resin molded article of the present invention is not particularly limited, and it is, for example, a film or a sheet.

The thickness of the resin molded article of the present invention as a film is, for example, at least 1 μm but less than 350 μm. Preferably, the thickness of the film is at least 10 μm but less than 350 μm. When the thickness is less than 1 μm, the strength of the film may be insufficient, and the film may be broken easily during the post-treatment such as stretching.

The thickness of the resin molded article of the present invention as a sheet is, for example, at least 350 μm but not more than 10 mm. Preferably, the thickness of the sheet is at least 350 μm but not more than 5 mm. When the thickness exceeds 10 mm, it is difficult to make the thickness of the sheet uniform, and it also is difficult to use the resin sheet as an optical member.

The resin sheet and the resin film can be formed, for example, by extruding the resin composition of the present invention.

The resin molded article of the present invention has a high Tg, and for example, the Tg value is 110° C. or higher. The Tg is 115° C. or higher, 120° C. or higher, or further 130° C. or higher depending on the composition of the resin composition that composes the resin sheet or the resin film.

The resin molded article of the present invention has a high ultraviolet absorbing ability. For example, in the case where the resin molded article is a film having a thickness of 100 μm, the film can have a light transmittance of less than 30% at a wavelength of 380 nm. The film further can have a light transmittance of less than 20%, less than 10%, or less than 1% in some cases.

The resin molded article of the present invention has a high visible light transmittance. For example, in the case where the resin molded article is a film having a thickness of 100 μM, the film can have a light transmittance of 80% or more at a wavelength of 500 nm. The film further can have a light transmittance 85% or more, 90% or more, or 92% or more in some cases. The light transmittance of the film (sheet) at a wavelength of 380 nm and a wavelength of 500 nm can be measured according to the method mentioned above.

Preferably, the resin molded article of the present invention has a tensile strength of at least 10 MPa but less than 100 MPa, and more preferably at least 30 MPa but less than 100 MPa, when measured according to ASTM D-882-61T. When the tensile strength is less than 10 MPa, the mechanical strength of the resin molded article as a resin sheet (film) may be insufficient. On the other hand, when the tensile strength exceeds 100 MPa, the processability of the resin molded article may deteriorate.

Preferably, the resin molded article of the present invention has an elongation rate of 1% or more when measured according to ASTM-D-882-61T. The upper limit of the elongation rate is not particularly limited, and it usually is 100% or less. When the elongation rate is less than 1%, the toughness of the resin sheet (film) may be insufficient.

It is preferable that the resin molded article of the present invention has a tensile modulus of 0.5 GPa or more when measured according to ASTM-D-882-61T. More preferably, the tensile modulus is 1 GPa or more, and still more preferably 2 GPa or more. The upper limit of the above tensile modulus is not particularly limited, and it usually is 20 GPa or less. When the tensile modulus is less than 0.5 GPa, the mechanical strength of the resin molded article as a resin sheet (film) may be insufficient.

Various functional coating layers may be formed on the surface of the resin molded article of the present invention as a sheet or a film. Examples of the functional coating layers include an antistatic layer, a pressure-sensitive adhesive layer, an adhesive layer, an easily adhesive layer, an antiglare (non-glare) layer, an antifouling layer such as a photocatalytic layer, an antireflection layer, a hard coat layer, an ultraviolet shielding layer, a heat radiation shielding layer, an electromagnetic radiation shielding layer, and a gas barrier layer. A member having any of the above-mentioned functional coating layers may be provided on the resin molded article of the present invention. The member can be bonded thereon with a pressure-sensitive adhesive or an adhesive.

The uses of the resin molded article of the present invention as a sheet or a film are not particularly limited. It can be used suitably as an optical member because of its high transparency, heat resistance and ultraviolet absorbing ability. The optical member is, for example, an optical protective film (sheet). Specifically, it is a protective film used in a substrate for various optical disks (e.g., VD, CD, DVD, MD, LD, etc.), or a polarizer protective film used in a polarizing plate of an image display apparatus such as a liquid crystal display (LCD). The resin molded article of the present invention may be used as an optical film such as a retardation film, a viewing angle compensation film, a light diffusing film, a reflection film, an antireflection film, an antiglare film, a brightness enhancing film, a conductive film for a touch panel, or as an optical sheet such as a diffusing plate, a light guide plate, a retardation plate, and a prism sheet.

As an example, a polarizer protective film is described below. An LCD has a pair of polarizing plates disposed on both sides of a liquid crystal cell therebetween based on its image display principle. Generally, a polarizing plate includes a polarizer made of a polyvinyl alcohol resin film or the like and a polarizer protective film for protecting the polarizer. Since the polarizer protective film of the present invention has high ultraviolet absorbing ability, it can suppress the deterioration of the polarizer caused by ultraviolet light. Since the polarizer protective film has high heat resistance, the polarizing plate can be placed near the light source. Further, since the polarizer protective film has high transparency, an image display apparatus having excellent image display characteristics can be formed.

Conventionally, a triacetyl cellulose (TAC) film is used as a polarizer protective film. However, the TAC film has insufficient heat and moisture resistance. When the TAC film is used as a polarizer protective film, the characteristics of the polarizing plate may be deteriorated in a high-temperature or high-humidity environment. Further, the TAC film has a retardation in the thickness direction. This retardation adversely affects the viewing angle characteristics of an image display apparatus such as an LCD, particularly a large screen image display apparatus. In contrast, since the polarizer protective film of the present invention is made of a resin composition containing an acrylic resin as a main component, it has improved heat and moisture resistance and optical properties compared to the TAC film.

The structure of the polarizing plate (polarizing plate of the present invention) including the polarizer protective film of the present invention is not particularly limited. The polarizer protective film may be formed on one surface of the polarizer, or the polarizer may be disposed between a pair of the polarizer protective films. A typical example of the structure of the polarizing plate of the present invention is a structure in which the polarizer protective film(s) of the present invention is (are) laminated, (each) via an adhesive layer or an easily adhesive layer, on one or both of the surfaces of the polarizer obtained by dyeing a polyvinyl alcohol film with a dichroic material such as iodine and a dichroic dye and then stretching the dyed film uniaxially.

The polarizer is not particularly limited and is a known polarizer. Examples of the known polarizer include: a polarizer obtained by dyeing a polyvinyl alcohol film and stretching the dyed film; a polarizer made of polyene such as dehydrated polyvinyl alcohol or dehydrochlorinated polyvinyl chloride; a reflective polarizer using a multilayered body or a cholesteric liquid crystal; and a polarizer made of a thin crystal film. Among them, a polarizer obtained by dyeing a polyvinyl alcohol film and stretching the dyed film is preferred. The thickness of the polarizer is not particularly limited, and commonly it is about 5 to 100 μm.

In the case where the polarizer and the polarizer protective film are laminated to each other, an adhesive to be used for the lamination is not particularly limited. Examples of the adhesive include adhesives each containing as a base material a resin such as polyurethane, polyester or polyacryl, and a variety of pressure-sensitive adhesives such as an acrylic adhesive, a silicon-based adhesive, and a rubber-based adhesive. The polarizer and the polarizer protective film may be laminated to each other by thermocompression as long as the functions of the polarizer are not impaired.

The polarizer and the polarizer protective film may be laminated to each other according to a known method. For example, an adhesive is applied to the laminating surface(s) of the polarizer and/or the polarizer protective film by a known method such as a casting method, a Meyer bar coating method, a gravure coating method, a die coating method, a dip coating method, and a spray coating method, and then the polarizer and the polarizer protective film are laminated to each other. The casting method as an adhesive applying method is a method for casting an adhesive onto the surface of a target film while moving the film so as to spread the adhesive all over the surface.

When the polarizer and the polarizer protective film are laminated to each other, the surface of the polarizer protective film to which the polarizer is to be laminated may be subjected to easy adhesion treatment. In this case, the adhesion between the polarizer and the polarizer protective film is improved. Examples of the easy adhesion treatment include a plasma treatment, a corona treatment, an ultraviolet irradiation treatment, a flame treatment, a saponification treatment, and an anchor layer formation treatment. Two or more of the treatments may be performed in combination. Among them, the corona treatment, the anchor layer formation treatment, and a combined use of these treatments are preferred.

The polarizing plate of the present invention may include an arbitrary member in addition to the polarizer and the polarizer protective film of the present invention. Examples of the arbitrary member include a TAC film, a polycarbonate film, a cyclic polyolefin film, an acrylic resin film, a polyethylene terephthalate film, and a polynaphthalene terephthalate film. Among them, the acrylic resin film is preferred because of its excellent optical properties as a polarizing plate. Further, it also is preferable that the polarizing plate has a low retardation film having a value of retardation (retardation per 100 μm thickness at a wavelength of 589 nm) of 10 nm or less in the in-plane and thickness directions, or a retardation film having a specific value of retardation. These arbitrary films do not have to function as polarizer protective films.

The polarizing plate of the present invention may include a hard coat layer in order to improve the surface properties thereof, for example, scratch resistance. Examples of the hard coat layer include layers made of silicone resins, acrylic resins, acrylic silicone resins, ultraviolet curable resins, and urethane-based hard coat agents. Examples of the ultraviolet curable resins include ultraviolet curable acrylic urethane, ultraviolet curable epoxy acrylate, ultraviolet curable (poly)ester acrylate, and ultraviolet curable oxetane. The hard coat layer usually has a thickness of 0.1 to 100 μm. Before the hard coat layer is formed, the base layer may be subjected to a primer treatment. The base layer also may be subjected to a known antiglare treatment such as an antireflection treatment or a low reflection treatment.

At least one outermost layer of the polarizing plate of the present invention may be a pressure-sensitive adhesive layer. In this case, the polarizing plate of the present invention can be bonded to the crystal liquid cell or other optical members. For example, the pressure-sensitive adhesive layer includes a pressure sensitive adhesive containing an acrylic resin, a silicone polymer, polyester, polyurethane, polyamide, polyether, a fluorine resin, a rubber polymer, or the like, as a base material.

The pressure-sensitive adhesive layer can be formed by a known method. For example, a pressure-sensitive adhesive solution with a concentration of about 10 to about 40% is prepared by dissolving or dispersing a pressure-sensitive adhesive in a solvent containing a medium such as toluene and ethyl acetate, and the prepared solution is cast or coated on the polarizing plate to obtain a pressure-sensitive adhesive layer. The pressure-sensitive adhesive layer also can be formed by casting or coating the prepared solution on a separator to obtain a layer and then transferring the resulting layer onto the polarizing plate from the separator.

In order to increase the adhesion between the pressure-sensitive adhesive layer and the base layer, an anchor layer may be provided therebetween. The anchor layer is made of, for example, polyurethane, polyester, and a polymer having an amino group in its molecule. Among them, the polymer having an amino group in its molecule is particularly preferred as an anchor layer. The amino group in the polymer molecule reacts with a polar group (for example, a carboxyl group) in the pressure-sensitive adhesive or ionically interacts with the polar group, so that good adhesion can be ensured.

Examples of the polymer having an amino group in its molecule include polyethyleneimine, polyallylamine, polyvinylamine, polyvinylpyridine, and polyvinylpyrrolidine. It may be a polymer substance obtained by polymerizing an amino group-containing monomer such as dimethylaminoethyl acrylate.

The polarizing plate of the present invention can be used in image display apparatuses typified by LCDs. In the case where the polarizing plate of the present invention is used in an LCD, the polarizing plate may be placed only on one of the backlight side and the visual recognition side of the liquid crystal cell, or on both sides thereof.

The image display apparatus in which the polarizing plate of the present invention can be used is not particularly limited. Examples of the image display apparatus include: reflection-type, transmission-type, and semi-transmission-type LCDs; LCDs of various driving modes such as a TN mode, an STN mode, an OCB mode, an HAN mode, a VA mode, and an IPS mode; electroluminescence (EL) displays; plasma displays (PD); and field emission displays (FED).

The configuration of the image display apparatus (image display apparatus of the present invention) including the polarizing plate of the present invention is not particularly limited. The image display apparatus may include members such as a retardation plate, an optical compensation sheet, and a backlight unit as appropriate.

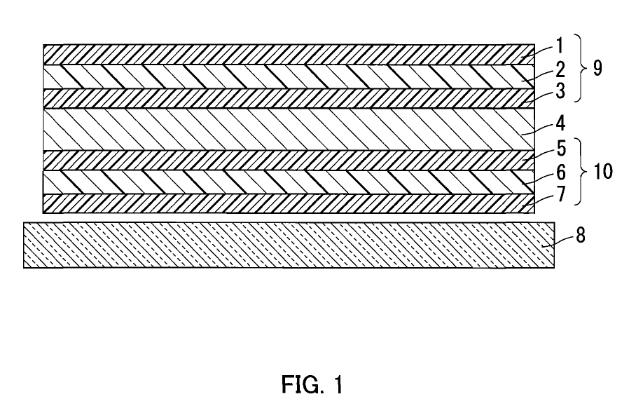

FIG. 1 shows an example of the structure of the image display portion in the image display apparatus of the present invention. An image display portion 11 shown in FIG. 1 is an image display portion of an LCD. This image display portion 11 includes a liquid crystal cell 4, a pair of polarizing plates 9 and 10 disposed to sandwich the liquid crystal cell 4 therebetween, and a backlight 8 placed on one surface of a layered body including the liquid crystal cell 4 and the polalizing plates 9 and 10. The polarizing plate 9 has a polarizer 2 and a pair of polarizer protective films 1 and 3 disposed to sandwich the polarizer 2, and the polarizing plate 10 has a polarizer 6 and a pair of polarizer protective films 5 and 7 disposed to sandwich the polarizer 6. The liquid crystal cell 4 has a known structure, and includes, for example, a liquid crystal layer, a glass substrate, a transparent electrode, an oriented film, etc. The backlight 8 has a known structure, and includes, for example, a light source, a reflection sheet, a light guide plate, a diffusing plate, a diffusing sheet, a prism sheet, a brightness enhancing film, etc.

The image display portion 11 may have any structure as long as at least one selected from the four polarizer protective films is the polarizer protective film of the present invention. Preferably, all the polarizer protective films are the polarizer protective films of the present invention. In the case where the ultraviolet light incident on the image display portion 11 from outside causes a problem, it is preferable that the polarizer protective film in the polarizing plate 9 located on the visual recognition side (on the side of the outside), among the polarizing plates 9 and 10 disposed on both sides of the liquid crystal cell 4, is the polarizer protective film of the present invention. It is more preferable that at least the polarizer protective film 1 located on the side of the outside, among the polarizer protective films 1 and 3 of the polarizing plate 9, is the polarizer protective film of the present invention.

The image display portion 11 further may have an arbitrary optical member such as a retardation plate or an optical compensation sheet as required.

[Production Method of Resin Molded Article]

As described above, the production method of the resin molded article of the present invention is not particularly limited. An example of the production method of a resin film as the resin molded article is described below. This production method is applicable to a production method of a resin sheet.

One of the methods of producing a resin film from the resin composition of the present invention is an extrusion molding method. As a specific example, respective components constituting the resin composition are mixed previously in a mixer such as an omni mixer and then the resulting mixture is kneaded and extruded from a kneader. The kneader used for kneading and extrusion is not particularly limited. For example, extruders such as a single-screw extruder and a twin-screw extruder, or known kneaders such as pressurized kneaders can be used.

The separately prepared resin composition may be melt-extruded. Examples of the melt-extrusion method include a T-die method and an inflation method. The temperature at which the extruded film is molded by such a method is preferably 200 to 350° C., more preferably 250 to 300° C., still more preferably 255 to 300° C., and particularly preferably 260 to 300° C.

If the T-die method is used, a T-die is attached to the end of the extruder. The resin composition is extruded from the T-die into a film, and the resulting film is wound up. Thus, a resin film that is wound up in a roll shape can be obtained. In this case, the film can be subjected to stretching in the extrusion direction (uniaxial stretching) while controlling the temperature and speed at which the film is wound up. The film also can be stretched in the direction perpendicular to the extrusion direction so as to be subjected to sequential biaxial stretching or simultaneous biaxial stretching.

In the case where an extruder is used for extrusion molding, the type of the extruder is not particularly limited. It may be a single-screw, twin-screw, or a multi-screw extruder. In order to plasticize the resin composition sufficiently to obtain a well-kneaded state, the L/D value (L is the length of a cylinder of the extruder and D is the inner diameter of the cylinder) of the extruder is preferably at least 10 but not more than 100, more preferably at least 20 but not more than 50, and still more preferably at least 25 but not more than 40. When the L/D value is less than 10, the resin composition cannot be plasticized sufficiently, and a well-kneaded state may not be obtained in some cases. On the other hand, when the L/D value exceeds 100, shear heat is generated and applied excessively to the resin composition, and thereby the resin in the composition may decompose thermally.

In this case, the preset temperature of the cylinder is preferably at least 200° C. but not higher than 300° C., and more preferably at least 250° C. but not higher than 300° C. When the preset temperature is less than 200° C., the melt viscosity of the resin composition becomes excessively high and thereby the productivity of the resin film decreases. On the other hand, when the preset temperature exceeds 300° C., the resin in the resin composition may decompose thermally.

In the case where an extruder is used for extrusion molding, the configuration of the extruder is not particularly limited. Preferably, the extruder is provided with one or more open vent portions. The use of such an extruder makes it possible to exhaust the decomposed gas through the open vent portion, and thereby reduce the volatile content remaining in the resulting resin film. In order to exhaust the decomposed gas through the open vent portion, the pressure of the open vent portion can be reduced, for example. The reduced pressure, that is, the pressure of the open vent portion, is preferably within a range of 931 to 1.3 hPa (700 to 1 mmHg), and more preferably within a range of 798 to 13.3 hPa (600 to 10 mmHg). When the pressure of the open vent portion is higher than 931 hPa, volatile components, monomer components generated by the decomposition of the resin, and the like tend to remain in the resin composition. On the other hand, it is difficult industrially to maintain the pressure of the open vent portion lower than 1.3 hPa.

In the case where a resin film to be used as an optical member such as an optical film is produced, a resin composition that has been filtered with a polymer filter may be molded. Since a polymer filter can be used to remove foreign substances present in the resin composition, defects in the outer appearance of the resulting film can be reduced. When the resin composition is filtered with the polymer filter, it is in a high-temperature molten state. Therefore, the resin composition is deteriorated when it passes through the polymer filter, and gas components and colored deteriorated components formed by the deterioration of the resin composition bleed out into the composition. As a result, defects such as holes, flow marks, and flow lines sometimes are observed in the resulting film. These defects often are observed particularly during the continuous molding of a resin film. Therefore, when a resin composition that has been filtered with a polymer filter is molded, the molding temperature is, for example, 255 to 300° C., and preferably 260 to 320° C., in order to reduce the melt viscosity of the resin composition and shorten the residence time of the resin composition in the polymer filter.

The structure of the polymer filter is not particularly limited. A polymer filter including a housing in which a large number of leaf disk-type filters are placed can be used suitably. As a leaf disk-type filter medium, any type of filter medium, such as a medium obtained by sintering metal fiber nonwoven fabric, a medium obtained by sintering metal powder, a medium obtained by piling up several metal nets, or a hybrid type medium obtained by combining any of these media, may be used. The medium obtained by sintering metal fiber nonwoven fabric is most preferred.

The filtration accuracy of the polymer filter is not particularly limited. It usually is 15μ or less, preferably 10μ or less, and more preferably 5μ or less. When the filtration accuracy is 1μ or less, the residence time of the resin composition becomes longer. As a result, not only the resin composition is deteriorated by heat significantly, but also the productivity of the resin film decreases. On the other hand, when the filtration accuracy exceeds 15μ, it becomes difficult to remove foreign substances in the resin composition.

In the polymer filter, the filtration area for the amount of resin to be filtered per hour is not particularly limited. It can be determined appropriately according to the amount of resin composition to be filtered. The above-mentioned filtration area is, for example, 0.001 to 0.15 m²/(kg/h).

The type of the polymer filter is not particularly limited. Examples of the polymer filter type include: an inside passage type having a plurality of resin inlets and having a polymer flow passage inside a center pole; and an outside passage type having a cross section of a center pole with its vertices or sides being in contact with the inner peripheral surface of a leaf disk filter and having a polymer flow passage along the outer surface of the center pole. It is particularly preferable to use an outside passage type filter in which the resin resides in fewer places.

The residence time of the resin composition in the polymer filter is not particularly limited. The residence time is preferably 20 minutes or less, more preferably 10 minutes or less, and still more preferably 5 minutes or less. The filter inlet pressure and the filter outlet pressure during filtration are, for example, 3 to 15 MPa and 0.3 to 10 MPa, respectively. Preferably, the pressure drop (a difference between the filter inlet pressure and the filter outlet pressure) is in a range of 1 MPa to 15 MPa. When the pressure drop is 1 MPa or less, the flow of the resin composition in the passage easily becomes non-uniform, and thereby the quality of the resulting resin film tends to deteriorate. On the other hand, when the pressure drop exceeds 15 MPa, the polymer filter is damaged easily.

The temperature of the resin composition to be introduced into the polymer filter may be determined appropriately according to the melt viscosity of the resin composition. For example, the temperature is 250 to 300° C., preferably 255 to 300° C., and further preferably 260 to 300° C.

The process of obtaining a resin film containing fewer foreign substances and colored substances by filtration using a polymer filter is not particularly limited to a specific one. Examples of the process are as follows: (1) a process in which the resin composition is formed and subjected to filtration in a clean environment, followed by molding of the resin composition in the clean environment; (2) a process in which the resin composition containing foreign substances or colored substances is subjected to filtration in a clean environment, followed by molding of the resin composition in the clean environment; and (3) a process in which the resin composition containing foreign substances or colored substances is subjected to filtration in a clean environment, and at the same time the resin composition is molded. In each of the processes, the resin composition may be subjected to filtration with a polymer filter two or more times.

During the filtration of the resin composition in a polymer filter, it is preferable to place a gear pump between the extruder and the polymer filter so as to stabilize the pressure of the resin composition in the filter.

It is preferable that after the resin composition of the present invention is produced, it is extruded and molded directly into a resin film. In this case, the thermal history can be reduced compared with the case where the resin composition is once pelletized and then the resulting pellet is melted again to be molded into a resin film. Therefore, the thermal degradation of the resin composition can be suppressed. In addition, this technique can reduce the inclusion of foreign substances from the surroundings. Accordingly, it is possible to reduce the presence of foreign substances in the resulting resin film or the coloring of the resulting resin film. It is preferable to place the gear pump and the polymer filter between the extruder and the T die.

The resin film obtained by extrusion molding may be stretched if necessary. The type of stretching is not particularly limited. It may be either uniaxial stretching or biaxial stretching. The mechanical strength of the resin film can be enhanced by stretching, and in some cases, the resin film can be imparted with birefringent properties. The resin composition of the present invention can maintain its optical isotropy even after it is stretched, depending on its composition. The stretching temperature is not particularly limited, and it is preferably in the vicinity of the Tg of the resin composition. The stretching ratio and the stretching speed also are not particularly limited.

In order to stabilize the optical properties and mechanical properties of the resin film, the stretched film may be subjected to heat treatment (annealing).

### Examples

Hereinafter, the present invention is described further in detail with reference to Examples. The present invention is not limited to the following Examples.

First, a method of evaluating resin composition samples prepared in the Examples is described.

[Glass Transition Temperature]

The glass transition temperature (Tg) of each sample was measured according to JIS K7121. Specifically, the temperature of about 10 mg of each sample was raised from room temperature to 200° C. (with a temperature rise rate of 20° C/min) in a nitrogen gas atmosphere to obtain a DSC curve by using a differential scanning calorimeter (DSC-8230 manufactured by Rigaku Co., Ltd.). Then, the glass transition temperature was evaluated based on the resulting DSC curve by a starting point method. As a reference sample, α-alumina was used. The Tg of each of the films produced in Production Examples also was evaluated in the same manner.

[Light Transmittance]

With respect to the light transmittance, each sample was extruded and molded into a film with a thickness of 100 μm, and then the light transmittances of each sample at wavelengths of 380 nm and 500 nm were measured with a spectrometer (UV-3100 manufactured by Shimadzu Corporation). Thus, the light transmittances of each sample were evaluated. A specific method of forming the film with a thickness of 100 μm from each sample is described later.

The light transmittances of each of the films produced Production Examples also was evaluated in the same manner, although the thicknesses of the films to be evaluated may be different from each other in some cases.

[Foaming Property]

The forming property of each sample was evaluated in the following manner. First, a pellet-shaped resin composition was dried with a hot air circulation type dryer (at 80° C. for 5 hours), and 6 g of the dried pellet was charged into a melt indexer specified in JIS K7210 with its temperature controlled at 280° C. Subsequently, the melt indexer was maintained at 280° C. for 20 minutes, and then the molten resin composition was extruded into a strand at a load of 4.85 kg. The state of foaming in the strands thus obtained was observed visually. In the case where at least 20 bubbles with a diameter of 0.5 mm or more were present in the strand within 10 cm below the lower marked line of the piston of the melt indexer, the state of foaming is defined as “foamed”. In the case where less than 20 bubbles were present, the state of foaming is defined as “not foamed”.

[Sublimation Property]

The sublimation property of the UVA in each sample was evaluated in the following manner. First, each sample was extruded and molded into a film with a thickness of 100 μm, and a part (1 cm×3 cm in size) thereof was cut out. Next, the film thus cut out was put into a test tube and heated at 150° C. for 10 hours in a metal bath. Next, the film was taken out of the test tube and then 1 mL of chloroform was poured into the test tube so as to dissolve the UVA, which had sublimed from the film and deposited on the inner wall of the test tube, into chloroform. Next, the chloroform in which the UVA was dissolved was placed in a quartz cell with an optical path length of 1 cm. The light absorbance of the resulting solution at a wavelength of 350 nm was measured with an absorption spectrometer (UV-3100 manufactured by Shimadzu Corporation). As the amount of sublimed UVA increases, the measured absorbance also increases.

[Scattering Property]

The amount of UVA adhered to a cast roll (a metal roll that the molten resin film extruded from a T-die first touches) was measured, and thereby the degree of contamination of a molding machine during the molding of each sample was evaluated. The amount of adhered UVA was evaluated in the following manner. First, the resin film was extruded and molded for one hour continuously by a molding machine provided with a cast roll. A 10 cm×10 cm area in the center of the roll was wiped with a cellulose wiper impregnated with chloroform. Next, the wiper used for wiping was immersed in 30 mL of chloroform to dissolve the UVA wiped from the cast roll into chloroform. Next, the chloroform in which the UVA was dissolved was placed in a quartz cell with an optical path length of 1 cm. The light absorbance of the resulting solution at a wavelength of 350 nm was measured with an absorption spectrometer (UV-3100 manufactured by Shimadzu Corporation). As the amount of the UVA adhered to the cast roll increases (that is, as the scattering property of the UVA increases), the measured absorbance also increases.

[Weight Average Molecular Weight]

The weight average molecular weight of the acrylic resin was measured by gel permeation chromatography (GPC) under the following conditions.

System: Product of Tosoh Corporation

Developing solvent: Chloroform (highest quality product manufactured by Wako Pure Chemical Industries, Ltd.) with a flow rate of 0.6 ml/min.

Standard sample: TSK standard polystyrene (PS-oligomer kit, type 12, manufactured by Tosoh Corporation)

Column configuration (measurement side): A guard column (TSK Guardcolumn Super H-H), and two separate columns (TSK gel Super HM-M) connected in series

Column configuration (Reference side): A reference column (TSK gel Super H-RC)

[Content of Lactone Ring Structure]

The content of a lactone ring structure in the acrylic resin was obtained in the following manner by a dynamic TG method. First, the acrylic resin having a lactone ring structure was subjected to dynamic TG measurement to measure the weight loss rate from 150 to 300° C. The obtained value was defined as a measured weight loss rate (X). 150° C. is a temperature at which a hydroxyl group and an ester group that remain in the resin start the cyclocondensation reaction. 300° C. is a temperature at which the resin starts to decompose thermally. Separately, assuming that all the hydroxyl groups contained in the polymer as a precursor underwent a dealcoholization reaction and thereby participated in the formation of a lactone ring, the weight loss rate obtained as a result of the reaction (that is, the weight loss rate obtained by assuming that 100% dealcoholization cyclocondensation reaction occurred in the precursor) was calculated, and the obtained value was defined as a theoretical weight loss rate (Y). Specifically, the theoretical weight loss rate (Y) can be calculated from the content of a structural unit having a hydroxyl group that participates in the dealcoholization in a precursor. The composition of the precursor was derived from the composition of the acrylic resin to be measured. Next, the dealcoholization reaction rate of the acrylic resin was obtained from an equation: [1−(measured weight loss rate (X)/theoretical weight loss rate (Y))]×100(%). It is considered that in the acrylic resin to be measured, the lactone ring structure was formed in an amount corresponding to the obtained dealcoholization reaction rate. Accordingly, the content of the structural unit having the hydroxyl group that participated in the dealcoholization reaction in the precursor was multiplied by the obtained dealcoholization reaction rate so as to convert the content into the weight of the lactone ring structure. Thus, the content of the lactone ring structure in the acylic resin was obtained.

As an example, the dealcoholization reaction rate of a resin (A-5) produced in Comparative Example 1 to be described later is calculated in the following manner. The molecular weight of methanol generated by the dealcoholization reaction is 32, the content of a MHMA unit that is a structural unit having a hydroxyl group that participates in the dealcoholization reaction in a precursor (copolymer of MHMA and MMA) is 20.0%, and the molecular weight of the MHMA unit is 116 on a monomer basis. Accordingly, the theoretical weight loss rate (Y) of the above resin (A) is (32/116)×20=5.52%. On the other hand, since the measured weight loss rate (X) of the above resin (A) is 0.18%, the dealcoholization reaction rate thereof is 96.7% (=(1−0.18/5.52)×100(%)).

Next, the content of the lactone ring structure in the above resin (A) is calculated. The content of the MHMA unit in the precursor is 20.0%, the molecular weight of the MHMA unit is 116 on a monomer basis, the dealcoholization reaction rate is 96.7%, and the formula weight of the lactone ring structure is 170. The content of the lactone ring structure in the above resin (A) is 28.3% (=20.0×0.967×170/116).

[Dynamic TG Measurement]

The dynamic TG measurement of the acrylic resin was carried out in the following manner.

The pellets of the obtained acrylic resin or the polymer solution of the unpelletized acrylic resin were dissolved in (or diluted with) tetrahydrofuran (THF), and then added into an excess of hexane or methanol so as to precipitate the resin therein. Next, the precipitate was dried under vacuum (at 1.33 hPa and 80° C. for at least 3 hours) to remove volatile components. Then, the resulting white solid resin was subjected to a dynamic TG measurement under the following conditions.

Measurement apparatus: Thermo Plus 2 TG-8120 Dynamic TG manufactured by Rigaku Co., Ltd.

Weight of sample: 5 to 10 mg

Temperature rise rate: 10° C./min.

Atmosphere: Nitrogen flow (200 ml/min)

Measurement method: Stepwise isothermal analysis (controlled at a value of weight loss rate of 0.005%/sec or less between 60 to 500° C.)

[Thickness of Film]

The thickness of the film was measured using a Digimatic Micrometer (manufactured by Mitsutoyo Corporation).

[Degree of Haze Change of Film]

The degree of haze change of the film formed from each sample was evaluated in the following manner. First, as each sample, a film with a thickness of 100 μm was prepared by extrusion molding, and a part (5 cm×5 cm in size) thereof was cut out. Next, the haze of the film thus cut out was measured with a haze meter (NDH-1001DP manufactured by Nippon Denshoku Industries Co., Ltd.), and the measured value was defined as an initial value. Next, the cut-out film was allowed to stand in a hot air dryer (manufactured by Tabai Seisakusho) at 100° C. for 200 hours. After the film was allowed to stand, the haze of the film was measured again, and the degree of change from the above initial value was obtained. Presumably, the bleed-out of the UVA by heat is one of the factors responsible for the haze change of the molded film.

The hazes of the films produced in Production Examples also were measured with the above haze meter.

### Example 1

40 parts of methyl methacrylate (MMA), 10 parts of methyl 2-(hydroxymethyl)acrylate (MHMA), 50 parts of toluene as a polymerization solvent, and 0.025 parts of antioxidant (ADEKASTAB 2112, manufactured by Asahi Denka Kogyo K.K.) were charged into a 30-liter reaction vessel equipped with a stirrer, a temperature sensor, a condenser tube, and a nitrogen inlet tube, and the mixture was heated to 105° C. while nitrogen gas was introduced thereinto. When the reflux started as the temperature of the mixture increased, 0.05 parts of t-amylperoxyisononanoate (Luperox 570 (trade name), manufactured by Arkema Yoshitomi, Ltd.) was added as a polymerization initiator, and simultaneously 0.10 parts of t-amylperoxyisononanoate was added dropwise over 3 hours so that the mixture was subjected to solution polymerization under reflux at about 105 to 110° C., and then the mixture further was aged for 4 hours.

To the resulting polymer solution, 0.05 parts of phosphoric acid 2-ethylhexyl ester (Phoslex A-8 (Trade name), manufactured by Sakai Chemical Industry Co., Ltd.) was added as a catalyst (cyclization catalyst) for the cyclocondensation reaction. Then, under reflux at about 90 to 110° C., the mixture was subjected to cyclocondensation reaction for 2 hours. The resulting polymer solution was heated in an autoclave at 240° C. for 30 minutes so that the resulting solution was subjected further to cyclocondensation reaction.

Then, the resulting polymer solution was introduced into a vent type twin-screw extruder (Φ=29.75 mm, L/D=30) equipped with one rear vent and four fore vents (the first, second, third, and fourth vents from the upstream side) at a processing rate of 2.0 kg/h in terms of the amount of resin. The extruder had a barrel temperature of 240° C., and its rotation speed was 100 rpm. The barrel was depressurized to 13.3 to 400 hPa (10 to 300 mmHg). Thus, the polymer solution was subjected to devolatilization. During the devolatilization, a separately prepared mixed solution of an antioxidant and a cyclization catalyst deactivator was added at a rate of 0.03 kg/h on the downstream side of the first vent, a separately prepared UVA solution was added at a rate of 0.05 kg/h on the downstream side of the second vent, and an ion-exchanged water was added at a rate of 0.01 kg/h on the downstream side of the third vent.

As the mixed solution of an antioxidant and a cyclization catalyst deactivator, a solution obtained by dissolving 50 parts of antioxidant (Sumilizer GS, manufactured by Sumitomo Chemical Industry Co., Ltd.) and 35 parts of zinc octoate as the deactivator (3.6% Nikka Octhix Zinc manufactured by Nihon Kagaku Sangyo Co., Ltd.) in 200 parts of toluene was used.

As the UVA solution, a solution obtained by dissolving, in 12.5 parts of toluene, 37.5 parts of CGL 777MPA (with 80% active ingredient, manufactured by Ciba Speciality Chemicals Inc.) was used. CGL 777MPA contains an ultraviolet absorber (with a molecular weight of 958) represented by the above formula (9) as a main component, and an ultraviolet absorber (with a molecular weight of 773) represented by the above formula (10) and an ultraviolet absorber (with a molecular weight of 1142) represented by the following formula (11) as sub-components.

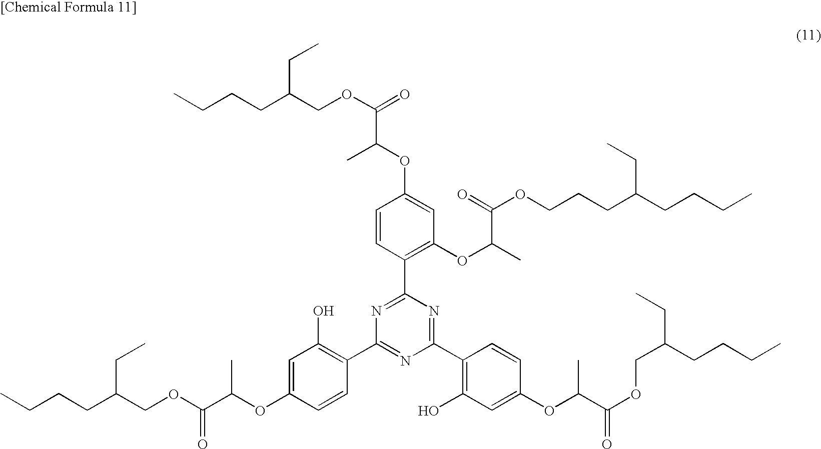

Next, after the devolatilization was completed, the thermally melted resin that remained in the extruder was extruded from the end of the extruder and then pelletized by a pelletizer. Thus, a transparent pellet of a resin composition containing an acrylic resin (A-1) having a lactone ring structure in its main chain and a UVA (B) with a molecular weight of 700 or more was obtained. The weight average molecular weight of the resin (A-1) was 148000, and the glass transition temperature (Tg) of the resin (A-1) and the resin composition was 128° C.

### Example 2

A transparent pellet of a resin composition containing an acrylic resin (A-1) having a lactone ring structure in its main chain and a UVA (B) with a molecular weight of 700 or more was obtained in the same manner as in Example 1 except that the UVA solution was added at a rate of 0.1 kg/h. The glass transition temperature (Tg) of the resin composition was 127° C.

### Example 3

41.5 parts of methyl methacrylate (MMA), 6 parts of methyl 2-(hydroxymethyl)acrylate (MHMA), 2.5 parts of 2-[2′-hydroxy-5′-methacryloyloxy]ethylphenyl]-2H-benzotriazole (RUVA-93 (trade name), manufactured by Otsuka Chemical Co., Ltd.), 50 parts of toluene as a polymerization solvent, 0.025 parts of antioxidant (ADEKASTAB 2112, manufactured by Asahi Denka Kogyo K.K.), and 0.025 parts of n-dodecyl mercaptan as a chain transfer agent were charged into a 30-liter reaction vessel equipped with a stirrer, a temperature sensor, a condenser tube, and a nitrogen inlet tube, and the mixture was heated to 105° C. while nitrogen gas was introduced thereinto. When the reflux started as the temperature of the mixture increased, 0.05 parts of t-amylperoxyisononanoate (Luperox 570 (trade name), manufactured by Arkema Yoshitomi, Ltd.) was added as a polymerization initiator, and simultaneously 0.10 parts of t-amylperoxyisononanoate was added dropwise over 3 hours so that the mixture was subjected to solution polymerization under reflux at about 105 to 110° C., and then the mixture further was aged for 4 hours.

To the resulting polymer solution, 0.05 parts of phosphoric acid 2-ethylhexyl ester (Phoslex A-8, manufactured by Sakai Chemical Industry Co., Ltd.) was added as a catalyst (cyclization catalyst) for the cyclocondensation reaction. Under reflux at about 90 to 110 C°, the mixture was subjected to cyclocondensation reaction for 2 hours. The resulting polymer solution was heated in an autoclave at 240° C. for 30 minutes so that the resulting solution was further subjected to cyclocondensation reaction. Next, 0.94 parts of the above CGL 777MPA as the UVA (B) was added to the polymer solution that had been subjected to the reaction.

Then, the resulting polymer solution was introduced into a vent type twin-screw extruder (Φ=50.0 mm, L/D=30) equipped with one rear vent and four fore vents (the first, second, third, and fourth vents from the upstream side) and in its end portion a leaf disk-type polymer filter (with a filtration accuracy of 5μ, and a filtration area of 1.5 m²) at a processing rate of 45 kg/h in terms of the amount of resin. The extruder had a barrel temperature of 240° C., and its rotation speed was 100 rpm. The barrel was depressurized to 13.3 to 400 hPa (10 to 300 mmHg). Thus, the polymer solution was subjected to devolatilization. During the devolatilization, a separately prepared mixed solution of an antioxidant and a cyclization catalyst deactivator was added at a rate of 0.68 kg/h on the downstream side of the first vent, and ion-exchanged water was added at a rate of 0.22 kg/h on the downstream side of the third vent. The mixed solution of an antioxidant and a cyclization catalyst deactivator used was the same as that used in Example 1.

Next, after the devolatilization was completed, the thermally melted resin that remained in the extruder was extruded from the end of the extruder while being filtered through the polymer filter, and then pelletized by a pelletizer. Thus, a transparent pellet of a resin composition containing an acrylic resin (A-2) having a lactone ring structure in its main chain and a UVA (B) with a molecular weight of 700 or more was obtained. The weight average molecular weight of the resin (A-2) was 145000, and the glass transition temperature (Tg) of the resin (A-2) and the resin composition was 122° C.

### Example 4

40 parts of methyl methacrylate (MMA), 10 parts of methyl 2-(hydroxymethyl)acrylate (MHMA), 50 parts of toluene as a polymerization solvent, and 0.025 parts of antioxidant (ADEKASTAB 2112, manufactured by Asahi Denka Kogyo K.K.) were charged into a 1000-liter reaction vessel equipped with a stirrer, a temperature sensor, a condenser tube, and a nitrogen inlet tube, and the mixture was heated to 105° C. while nitrogen gas was introduced thereinto. When the reflux started as the temperature of the mixture increased, 0.05 parts of t-amylperoxyisononanoate (Luperox 570 (trade name), manufactured by Arkema Yoshitomi, Ltd.) was added as a polymerization initiator, and simultaneously 0.10 parts of t-amylperoxyisononanoate was added dropwise over 3 hours so that the mixture was subjected to solution polymerization under reflux at about 105 to 110° C., and then the mixture further was aged for 4 hours.

To the resulting polymer solution, 0.05 parts of phosphoric acid 2-ethylhexyl ester (Phoslex A-8, manufactured by Sakai Chemical Industry Co., Ltd.) was added as a catalyst (cyclization catalyst) for the cyclocondensation reaction. Under reflux at about 90 to 110° C., the mixture was subjected to cyclocondensation reaction for 2 hours. The resulting polymer solution was heated in an autoclave at 240° C. for 30 minutes so that the resulting solution further was subjected to cyclocondensation reaction. Next, 0.94 parts of the above CGL 777MPA as the UVA (B) was added to the polymer solution that had been subjected to the reaction.

Then, the resulting polymer solution was introduced into a vent type twin-screw extruder (Φ=50.0 mm, L/D=30) equipped with one rear vent and four fore vents (the first, second, third, and fourth vents from the upstream side) and in its end portion a leaf disk-type polymer filter (with a filtration accuracy of 5μ, and a filtration area of 1.5 m²) at a processing rate of 45 kg/h in terms of the amount of resin. The extruder had a barrel temperature of 240° C., and its rotation speed was 100 rpm. The barrel was depressurized to 13.3 to 400 hPa (10 to 300 mmHg). Thus, the polymer solution was subjected to devolatilization. During the devolatilization, a separately prepared mixed solution of an antioxidant and a cyclization catalyst deactivator was added at a rate of 0.68 kg/h on the downstream side of the first vent, and ion-exchanged water was added at a rate of 0.22 kg/h on the downstream side of the third vent. The mixed solution of an antioxidant and a cyclization catalyst deactivator used was the same as that used in Example 1.

Next, after the devolatilization was completed, the thermally melted resin that remained in the extruder was extruded from the end of the extruder while being filtered through the polymer filter, and then pelletized by a pelletizer. Thus, a transparent pellet of a resin composition containing an acrylic resin (A-3) having a lactone ring structure in its main chain and a UVA (B) with a molecular weight of 700 or more was obtained. The weight average molecular weight of the resin (A-3) was 140000, and the glass transition temperature (Tg) of the resin (A-3) and the resin composition was 128C.

### Example 5

40 parts of methyl methacrylate (MMA), 10 parts of methyl 2-(hydroxymethyl)acrylate (MHMA), 50 parts of toluene as a polymerization solvent, and 0.025 parts of antioxidant (ADEKASTAB 2112, manufactured by Asahi Denka Kogyo K.K.) were charged into a 1000-liter reaction vessel equipped with a stirrer, a temperature sensor, a condenser tube, and a nitrogen inlet tube, and the mixture was heated to 105° C. while nitrogen gas was introduced thereinto. When the reflux started as the temperature of the mixture increased, 0.05 parts of t-amylperoxyisononanoate (Luperox 570 (trade name), manufactured by Arkema Yoshitomi, Ltd.) was added as a polymerization initiator, and simultaneously 0.10 parts of t-amylperoxyisononanoate was added dropwise over 3 hours so that the mixture was subjected to solution polymerization under reflux at about 105 to 110° C., and then the mixture further was aged for 4 hours.

To the resulting polymer solution, 0.05 parts of phosphoric acid 2-ethylhexyl ester (Phoslex A-8, manufactured by Sakai Chemical Industry Co., Ltd.) was added as a catalyst (cyclization catalyst) for the cyclocondensation reaction. Under reflux at about 90 to 110° C., the mixture was subjected to cyclocondensation reaction for 2 hours. The resulting polymer solution was heated in an autoclave at 240° C. for 30 minutes so that the resulting solution further was subjected to cyclocondensation reaction.

Then, the resulting polymer solution was introduced into a vent type twin-screw extruder (Φ=50.0 mm, L/D=30) equipped with one rear vent and four fore vents (the first, second, third, and fourth vents from the upstream side), a side feeder provided between the third vent and the fourth vent, and in its end portion a leaf disk-type polymer filter (with a filtration accuracy of 5μ, and a filtration area of 1.5 m²) at a processing rate of 45 kg/h in terms of the amount of resin. The extruder had a barrel temperature of 240° C., and its rotation speed was 100 rpm. The barrel was depressurized to 13.3 to 400 hPa (10 to 300 mmHg). Thus, the polymer solution was subjected to devolatilization. During the devolatilization, a separately prepared mixed solution of an antioxidant and a cyclization catalyst deactivator was added at a rate of 0.68 kg/h on the downstream side of the first vent, a separately prepared UVA solution was added at a rate of 1.25 kg/h on the downstream side of the second vent, and ion-exchanged water was added at a rate of 0.22 kg/h on the downstream side of the third vent. The mixed solution of an antioxidant and a cyclization catalyst deactivator and the UVA solution used were the same as those used in Example 1. A styrene-acrylonitrile (AS) resin pellet (Stylac AS783, manufactured by Asahi Kasei Chemicals Corporation) was fed through the side feeder at a rate of 5 kg/h.

Next, after the devolatilization was completed, the thermally melted resin that remained in the extruder was extruded from the end of the extruder while being filtered through the polymer filter, and then pelletized by a pelletizer. Thus, a transparent pellet of a resin composition containing an acrylic resin (A-4) having a lactone ring structure in its main chain and a UVA (B) with a molecular weight of 700 or more was obtained. The weight average molecular weight of the resin (A-4) was 145000, and the glass transition temperature (Tg) of the resin (A-4) and the resin composition was 126° C.

### Comparative Example 1

40 parts of methyl methacrylate (MMA), 10 parts of methyl 2-(hydroxymethyl)acrylate (MHMA), 50 parts of toluene as a polymerization solvent, and 0.025 parts of antioxidant (ADEKASTAB 2112, manufactured by Asahi Denka Kogyo K.K.) were charged into a 30-liter reaction vessel equipped with a stirrer, a temperature sensor, a condenser tube, and a nitrogen inlet tube, and the mixture was heated to 105° C. while nitrogen gas was introduced thereinto. When the reflux started as the temperature of the mixture increased, 0.05 parts of t-amylperoxyisononanoate (Luperox 570 (trade name), manufactured by Arkema Yoshitomi, Ltd.) was added as a polymerization initiator, and simultaneously 0.10 parts of t-amylperoxyisononanoate was added dropwise over 3 hours so that the mixture was subjected to solution polymerization under reflux at about 105 to 110° C., and then the mixture further was aged for 4 hours.

To the resulting polymer solution, 0.05 parts of phosphoric acid 2-ethylhexyl ester (Phoslex A-8, manufactured by Sakai Chemical Industry Co., Ltd.) was added as a catalyst (cyclization catalyst) for the cyclocondensation reaction. Under reflux at about 90 to 110° C., the mixture was subjected to cyclocondensation reaction for 2 hours. The resulting polymer solution was heated in an autoclave at 240° C. for 30 minutes so that the resulting solution further was subjected to cyclocondensation reaction.

Then, the resulting polymer solution was introduced into a vent type twin-screw extruder (Φ=29.75 mm, L/D=30) equipped with one rear vent and four fore vents (the first, second, third, and fourth vents from the upstream side) at a processing rate of 2.0 kg/h in terms of the amount of resin. The extruder had a barrel temperature of 240° C., and its rotation speed was 100 rpm. The barrel was depressurized to 13.3 to 400 hPa (10 to 300 mmHg). Thus, the polymer solution was subjected to devolatilization. During the devolatilization, a separately prepared mixed solution of an antioxidant and a cyclization catalyst deactivator was added at a rate of 0.03 kg/h on the downstream side of the first vent, and an ion-exchanged water was added at a rate of 0.01 kg/h on the downstream side of the third vent. The mixed solution of an antioxidant and a cyclization catalyst deactivator used was the same as that used in Example 1.

Next, after the devolatilization was completed, the thermally melted resin that remained in the extruder was extruded from the end of the extruder and then pelletized by a pelletizer. Thus, an acrylic resin (A-5) having a lactone ring structure in its main chain was obtained. The weight average molecular weight of the resin (A-5) was 148000.

100 parts of the resin (A-5) thus obtained and 1.5 parts of UVA having a benzotriazole skeleton (ADEKASTAB LA-31 with a molecular weight of 659, manufactured by ADEKA Corporation) were dry-blended. Thus, a resin composition containing the resin (A-5) and the UVA was obtained. The Tg of the resin (A-5) and the resin composition was 128° C.

### Comparative Example 2

A resin composition containing the resin (A-5) and the UVA was obtained in the same manner as in Example 1 except that 3.0 parts of the UVA was dry-blended with the resin (A-5). The Tg of the resin composition was 127° C.

### Comparative Example 3

100 parts of the resin (A-5) obtained in Comparative Example 1 and 1.5 parts of UVA having a benzotriazole skeleton (Sumisorb 300 with a molecular weight of 315, manufactured by Sumitomo Chemical Co., Ltd.) were dry-blended. Thus, a resin composition containing the resin (A-5) and the UVA was obtained. The Tg of the resin composition was 128° C.

### Comparative Example 4

100 parts of the resin (A-5) obtained in Comparative Example 1 and 1.5 parts of UVA having a skeleton in which one hydroxyphenyl group was bonded with triazine (CGL 479 (TINUVIN 479) with a molecular weight of 676, manufactured by Ciba Speciality Chemicals Inc.) were dry-blended. Thus, a resin composition containing the resin (A-5) and the UVA was obtained. The Tg of the resin composition was 128° C.

### Example 6

As an acrylic resin (A-6) having a ring structure in its main chain, an acrylic resin containing glutarimide (KAMAX T-240, manufactured by Rohm and Haas Company) was charged into a hopper. The resin was melted in a twin-screw extruder (Φ=30 mm, L/D=42) equipped with two vents under the conditions of a barrel temperature of 260° C., a rotation speed of 100 rpm, a reduced pressure of 13 hPa, and a processing rate of 10 kg/h. Next, a mixed solution of 19 parts by weight of CGL 777MPAD (with 80 wt. % active ingredient, manufactured by Ciba Speciality Chemicals Inc.) as a UVA (B) and 11 parts by weight of toluene was injected under pressure into the molten resin (A-6) from an injection port located upstream of the vent at a rate of 0.30 kg/h. Thus, a transparent pellet of a resin composition containing the acrylic resin (A-6) having a glutarimide structure in its main chain and a UVA (B) with a molecular weight of 700 or more was obtained. The glass transition temperature (Tg) of the resin (A-6) and the resin composition thus obtained was 135° C. The amount of the UVA (B) contained in the resulting resin composition was 1.5 parts with respect to 100 parts of the resin (A-6), when calculated from the processing rate of the resin (A-6) and the injection rate of the UVA (B).

The glutarimide-containing acrylic resin used as the resin (A-6) has in its main chain a glutarimide structure including a nitrogen atom as X¹ and CH₃ as R⁶ to R⁸ in the above formula (2). The CGL 777MPAD used as the UVA (B) contains the same main component and sub-components as CGL 777MPA used in Example 1.

### Example 7

As an acrylic resin (A-7) having a ring structure in its main chain, an acrylic resin containing glutaric anhydride (Sumipex B-TR, manufactured by Sumitomo Chemical Co., Ldt.) was charged into a hopper. The resin was melted in a twin-screw extruder (Φ=30 mm, L/D=42) equipped with two vents under the conditions of a barrel temperature of 260° C., a rotation speed of 100 rpm, a reduced pressure of 13 hPa, and a processing rate of 10 kg/h. Next, a mixed solution of 19 parts by weight of CGL 777MPAD (with 80 wt. % active ingredient, manufactured by Ciba Speciality Chemicals Inc.) as a UVA (B) and 11 parts by weight of toluene was injected under pressure into the molten resin (A-7) from an injection port located upstream of the vent at a rate of 0.30 kg/h. Thus, a transparent pellet of a resin composition containing the acrylic resin (A-7) having a glutaric anhydride structure in its main chain and a UVA (B) with a molecular weight of 700 or more was obtained. The glass transition temperature (Tg) of the resin (A-7) and the resin composition thus obtained was 120° C. The amount of the UVA (B) contained in the resulting resin composition was 1.5 parts with respect to 100 parts of the resin (A-7), when calculated from the processing rate of the resin (A-7) and the injection rate of the UVA (B).

The glutaric anhydride-containing acrylic resin used as the resin (A-7) has in its main chain a glutaric anhydride structure including an oxygen atom as X¹ and CH₃ as R⁶ and R⁷ in the above formula (2).

### Example 8

42.5 parts of methyl methacrylate, 5 parts of N-phenylmaleimide, 0.5 parts of styrene, 50 parts of toluene as a polymerization solvent, 0.2 parts of acetic anhydride as an organic acid, and 0.06 parts of n-dodecyl mercaptan as a chain transfer agent were charged into a 100-liter stainless steel polymerization vessel equipped with a dropping tank and a stirrer. The resulting mixture was bubbled with nitrogen gas for 10 minutes while being stirred at a rotation speed of 100 rpm. Next, the mixture in the polymerization vessel was heated while maintaining the nitrogen atmosphere in the vessel. When the temperature in the vessel reached 100° C., 0.075 parts of t-butylperoxyisopropyl carbonate was added, and at the same time, bubbling of the resulting mixture with nitrogen gas was started in the dropping tank. Next, a mixed solution of 2 parts of styrene and 0.075 parts of t-butylperoxyisopropyl carbonate was added into the vessel over 5 hours at a constant rate so that the mixture was subjected to polymerization reaction under reflux at about 105 to 110° C. for 15 hours.

Next, 0.1 parts of 9,10-dihydro-9-oxa-10-phosphaphenanthrene-10-oxide (HCA, manufactured by Sanko Chemical co., Ltd.) as a phosphorous antioxidant and 0.02 parts of pentaerythrityl-tetrakis[3-(3,5-di-tert-butyl-4-hydroxyphenyl)propionate] (AO-60, manufactured by ADEKA Corporation) as a phenol antioxidant were added into the resulting polymer solution.

Then, the resulting polymer solution containing the antioxidants added was introduced into a vent type twin-screw extruder (Φ=29.75 mm, L/D=30) equipped with one rear vent and four fore vents at a processing rate of 2.0 kg/h in terms of the amount of resin. The extruder had a barrel temperature of 240° C., and its rotation speed was 100 rpm. The barrel was depressurized to 13.3 to 400 hPa (10 to 300 mmHg). Further, a mixed solution of 19 parts by weight of CGL 777MPAD (with 80 wt. % active ingredient, manufactured by Ciba Speciality Chemicals Inc.) as a UVA (B) and 11 parts by weight of toluene was injected under pressure from an injection port located upstream of the third fore vent at a rate of 0.06 kg/h. Thus, a transparent pellet of a resin composition containing an acrylic resin (A-8) having a N-phenylmaleimide structure in its main chain and a UVA (B) with a molecular weight of 700 or more was obtained. The glass transition temperature (Tg) of the resin (A-8) and the resin composition thus obtained was 133° C. The amount of the UVA (B) contained in the resulting resin composition was 1.5 parts with respect to 100 parts of the resin (A-8), when calculated from the processing rate of the resin (A-8) and the injection rate of the UVA (B).

### Comparative Example 5

A mixture of 100 parts of the glutaric anhydride-containing acrylic resin (A-7) ᵤₛₑd in Example 7 and 1.5 parts of UVA having a benzotriazole skeleton (Sumisorb 300 with a molecular weight of 315, manufactured by Sumitomo Chemical Co., Ltd.) was charged into a hopper. The mixture was melted in the twin-screw extruder used in Example 6 under the conditions of a barrel temperature of 260° C., a rotation speed of 100 rpm, a reduced pressure of 13 hPa, and a processing rate of 10 kg/h. Thus, a resin composition containing the resin (A-7) and the UVA was obtained. The amount of the UVA contained in the resulting resin composition was 1.5 parts with respect to 100 parts of the thermoplastic resin (glutaric anhydride-containing acrylic resin) contained in the composition.

Sumisorb 300 is a benzotriazole-based ultraviolet absorber, and does not have a hydroxyphenyltriazine skeleton.

### Comparative Example 6

A mixture of 90 parts of the glutarimide-containing acrylic resin (A-6) used in Example 6, 10 parts of an acrylonitrile-styrene (AS) resin (Stylac AS783, manufactured by Asahi Kasei Chemicals Corporation), and 6 parts of a UVA having a skeleton in which two hydroxyphenyl groups were bonded with triazine (TINUVIN 460 with a molecular weight of 595, manufactured by Ciba Speciality Chemicals Inc.) was charged into a hopper. The mixture was melted in the twin-screw extruder used in Example 6 under the conditions of a barrel temperature of 260° C., a rotation speed of 100 rpm, a reduced pressure of 13 hPa, and a processing rate of 10 kg/h. Thus, a resin composition containing the resin (A-6) and the UVA was obtained. The amount of the UVA contained in the resulting resin composition was 6 parts with respect to 100 parts of the thermoplastic resin (glutarimide-containing acrylic resin) contained in the composition.

### Comparative Example 7

A resin composition containing the resin (A-8) and a UVA was obtained in the same manner as in Example 6 except that a mixed solution of 10 parts of Sumisorb 300 (manufacatured by Sumitomo Chemical Industry Co., Ltd.) as the UVA and 10 parts of toluene, instead of a mixed solution of CGL 777MPAD and toluene, was injected under pressure into the polymer solution containing an antioxidant added thereinto. The amount of the UVA contained in the resulting resin composition was 1.5 parts with respect to 100 parts of the resin (A-8), when calculated from the processing rate of the resin (A-8) and the injection rate of the UVA.

Tables 1 and 2 show the evaluation results of the above-mentioned properties of the resin compositions obtained in Examples 1 to 8 and Comparative Examples 1 to 7.

Resin films having a thickness of 100 μm were used for evaluating the properties, and these resin films were produced by extrusion molding of the resin compositions obtained in respective Examples and Comparative Examples. A specific method of the extrusion molding is as follows.

In Examples 4 and 5, each of the obtained resin compositions first was introduced into a vent type single screw extruder equipped with a barrier flight screw at a processing rate of 30 kg/h, and melt-kneaded in the extruder while removing volatile components from a vent hole at a pressure of 10 mmHg. Subsequently, the thermally melted resin compound that remained in the extruder was filtered through a leaf disk-type polymer filter (with a filtration accuracy of 5 μm and a filtration area of 0.75 m²) using a gear pump. The filtered resin composition was discharged from a T-die (with a width of 700 mm) onto a cooling roll at a temperature of 90° C. Thus, a resin film with a thickness of 100 μm was obtained. In this case, the temperature of the cylinder, the gear pump, the polymer filter, and the T-die was 265° C.

In Examples except for Examples 4 and 5 as well as Comparative Examples, the obtained resin composition first was introduced into a single screw extruder equipped with a cylinder having a diameter of 20 mm, and melted there. Then, the thermally melted resin composition in the extruder was discharged from a T-die (with a width of 120 mm) onto a cooling roll at a temperature of 110° C. Thus, a resin film with a thickness of 100 μm was obtained. In this case, the temperature of the cylinder and the T-die was 280° C.

TABLE 1

| | | Molecular | | | | | | | | |
|---|---|---|---|---|---|---|---|---|---|---|
| | UVA | weight | Example 1 | Example 2 | Example 3 | Example 4 | Example 5 | Example 6 | Example 7 | Example 8 |
| Amount of UVA | CGL777 | 958⁽*¹⁾ | 1.5 | 3.0 | 1.5 | 1.5 | 1.5 | 1.5 | 1.5 | 1.5 |
| contained (parts | MPA(D) | | | | | | | | | |
| by weight) with | CGL479 | 676 | — | — | — | — | — | — | — | — |
| respect to 100 | LA-31 | 659 | — | — | — | — | — | — | — | — |
| parts by weight | Sumisorb | 315 | — | — | — | — | — | — | — | — |
| of acrylic resin | 300 | | | | | | | | | |
| | TINUVIN | 595 | — | — | — | — | — | — | — | — |
| | 460 | | | | | | | | | |

| | | | | | | | | |
|---|---|---|---|---|---|---|---|---|
| Glass transition temperature (° C.) | 128 | 127 | 122 | 128 | 126 | 135 | 120 | 133 |
| Foaming property | No | No | No | No | No | Not | Not | Not |
| | | | | | | measured | measured | measured |
| Transmittance (%, 380 nm) | 0.2 | 0.01 or | 0.2 | 0.2 | 0.2 | 0.2 | 0.2 | 0.2 |
| | | less | | | | | | |
| Transmittance (%, 500 nm) | 92.1 | 92.0 | 92.3 | 92.3 | 92.1 | 91.3 | 90.3 | 90.1 |
| Absorbance (Sublimation property) | 0 | 0 | 0 | 0 | 0 | 0 | 0 | 0 |
| Absorbance (Scattering property) | 0.01 or | 0.01 or | 0.01 or | 0.01 or | 0.01 or | 0.01 or | 0.01 or | 0.01 or |
| | less | less | less | less | less | less | less | less |
| Degree of haze change | 0 | 0 | 0 | 0 | 0 | 0 | 0 | 0 |

⁽*¹⁾Molecular weight of main component

TABLE 2

| | | Molecular | Com. | Com. | Com. | Com. | Com. | Com. | Com. |
|---|---|---|---|---|---|---|---|---|---|
| | UVA | weight | Example 1 | Example 2 | Example 3 | Example 4 | Example 5 | Example 6 | Example 7 |
| Amount of | CGL777 | 958⁽*¹⁾ | — | — | — | — | — | — | — |
| UVA | MPA(D) | | | | | | | | |
| contained | CGL479 | 676 | — | — | — | 1.5 | — | — | — |
| (parts by | LA-31 | 659 | 1.5 | 3.0 | — | — | — | — | — |
| weight) with | Sumisorb | 315 | — | — | 1.5 | — | 1.5 | — | 1.5 |
| respect to 100 | 300 | | | | | | | | |
| parts by | TINUVIN | 595 | — | — | — | — | — | 6.0 | — |
| weight of | 460 | | | | | | | | |
| acrylic resin | | | | | | | | | |

| | | | | | | | |
|---|---|---|---|---|---|---|---|
| Glass transition temperature (° C.) | 128 | 127 | 128 | 128 | 122 | 134 | 134 |
| Foaming property | No | Yes | Yes | No | Not | Not | Not |
| | | | | | measured | measured | measured |
| Transmittance (%, 380 nm) | 2.0 | 0.1 | 0.01 or less | 2.5 | 0.1 | 0.1 or less | 0.1 |
| Transmittance (%, 500 nm) | 92.0 | 91.9 | 92.0 | 92.2 | 90.6 | 90.0 | 90.0 |
| Absorbance (Sublimation property) | 0.02 | 0.05 | 0.10 | 0.07 | 0.10 or less | 0.08 | 0.10 or less |
| Absorbance (Scattering property) | 0.17 | 0.31 | 0.77 | 0.02 | 1.00 | 0.70 | 1.20 |
| Degree of haze change | 0 | 0.1 | 0.2 | 0.3 | 0.5 | 0.3 | 0.5 |

⁽*¹⁾Molecular weight of main component

As shown in Tables 1 and 2, each of the resin compositions of Examples succeeded in suppressing the sublimation property and scattering property of the UVA during the molding thereof compared with the compositions of Comparative Examples, while achieving a high glass transition temperature, ultraviolet absorbing ability, and visible light transmittance. Further, in the resin compositions of Examples 1 to 5, foaming during the molding thereof was suppressed.

The rates of haze change of the resin films produced from the resin compositions of Examples 1 to 8 were smaller than those of the resin films produced from the resin compositions of Comparative Examples (except for Comparative Example 1). It is believed that in the resin films produced from the resin compositions of Examples, bleed-out of the UVA caused by heat after the formation of the films was suppressed compared with those of Comparative Examples.

### Production Example 1

The pellet of the resin composition produced in Example 3 was melted and extruded from a coat hanger type T-die with a width of 150 mm using a twin-screw extruder equipped with 20 mm φ screws to obtain a resin film with a thickness of about 160 μm.

Next, a square sample of 127 mm long on each side was cut out from the obtained resin film that had not yet been stretched, and then fastened to the chucks of a corner stretch type biaxial stretching tester (X6-S, manufactured by Toyo Seiki Seisakusho, Ltd.). The distance between the chucks was set to 110 mm in both the end-to-end and side-to-side directions. After being pre-heated at 160° C. for 3 minutes, the sample was subjected to a first stage of uniaxial stretching by a factor of 2.0 for 1 minute. The first stage of stretching was carried out so that the sample did not shrink in the width direction (perpendicular to the stretching direction) of the film.

After being stretched uniaxially, the sample was taken out of the tester quickly and cooled. Subsequently, another square sample of 97 mm long on each side was cut out from the sample thus cooled, and subjected to a second stage of uniaxial stretching in the same manner as in the first stage of uniaxial stretching. The second stage of stretching was performed in the direction perpendicular to the direction of the first stage of stretching. When the film was placed in the tester, the distance between the chucks was set to 80 mm in both the end-to-end and side-to-side directions. The sample was pre-heated at 160° C. for 3 minutes in the same manner as in the first stage, and then subjected to the second stage of stretching by a factor of 2.0 for 1 minute. The second stage of stretching was carried out so that the sample did not shrink in the width direction of the film.

After the second stage of stretching, the resulting resin film was taken out of the tester quickly and cooled. The physical properties of the biaxially stretched resin film thus obtained were measured. As a result, the thickness was 40 mm, the haze was 0.3%, the glass transition temperature was 128° C., the light transmittance at a wavelength of 380 nm was 5.8%, and the light transmittance at a wavelength of 500 nm was 92.2%.

### Production Example 2

An unstretched polyvinyl alcohol (PVA) film having a degree of saponification of 99% and a thickness of 75 μm was washed with water at room temperature, and uniaxially stretched (at a stretching ratio of 5) in the MD direction. The stretched film was dipped in an aqueous solution of iodine (with a concentration of 0.5%) and potassium iodine (with a concentration of 5%) while maintaining the tension of the film, so that the dichroic dye was adsorbed onto the PVA film. Subsequently, the film adsorbed with the dye was dipped in an aqueous solution of boric acid (with a concentration of 10%) and potassium iodine (with a concentration of 5%) at a temperature of 50° C. for 5 minutes, so that the film was subjected to cross-linking treatment. Thus, a polarizer including a stretched PVA film as a base was obtained.

### Production Example 3

200 parts of toluene and 100 parts of isopropyl alcohol as solvents, as well as 80 parts of butyl methacrylate, 25 parts of butyl acrylate, 75 parts of methyl methacrylate and 20 parts of methacrylic acid as monomers were added into a four-necked flask equipped with a thermometer, a stirrer, a condenser, a dropping funnel, and a nitrogen gas inlet tube, and the mixture was heated to 85° C. under stirring while nitrogen gas was introduced thereinto.

Then, as a polymerization initiator, a mixture of 0.005 parts of 2,2′-azobisisobutyronitrile (ABN-R (trade name), manufactured by Japan Hydrazine Co., Inc.) and 10 parts of toluene was added in several portions into the flask over 7 hours. Next, the mixture was aged at 85° C. for 3 hours, and then cooled to room temperature. Thus, a polymer having a weight average molecular weight of 90000 was obtained.

Next, after the temperature of the flask containing the polymer was raised to 40° C., 20 parts of ethyleneimine was added dropwise into the flask over 1 hour. The temperature of the flask was maintained for another 1 hour, and then the temperature in the flask was raised to 75° C. and the aging was carried out for 4 hours. Next, a distillation apparatus was placed in the flask, and the reaction mixture was heated while reducing the pressure to remove isopropyl alcohol and unreacted ethyleneimine from the system. Finally, toluene was added to adjust the concentration of non-volatile components to 10%. Thus, an easily adhesive layer coating composition (D-1) containing an ethyleneimine-modified acrylic polymer (having an amino group in its side chain was obtained.

### Production Example 4

In a reaction vessel equipped with a thermometer, a nitrogen gas inlet tube, and a stirrer, 367.2 parts of 1,4-butanediol, 166 parts of isophthalic acid and 0.05 parts of dibutyltin oxide were melted together under heating and stirring while nitrogen gas was introduced thereinto, so that a condensation reaction was carried out at 200° C. for 8 hours until the acid value of the mixture became 1.1. Next, the reaction vessel was cooled to 120° C., and 584 parts of adipic acid and 268 parts of 2,2-dimethylol propionate were added. Then, the temperature of the reaction vessel again was raised to 170° C., at which the mixture was allowed to react for 23 hours. Thus, polyester polyol having a hydroxyl value of 102.0 and an acid value of 93.5 was obtained. Next, 55 parts of the polyester polyol thus obtained was dehydrated at 100° C. under reduced pressure, and cooled to 60° C. 6.58 parts of 1,4-butanediol further was added, and the resulting mixture was stirred and mixed sufficiently. Next, 35.17 parts of hexamethylene diisocyanate was added, and then the reaction vessel was heated to 100° C., at which the mixture was allowed to react for 4.5 hours. Thus, an NCO-terminated urethane prepolymer was obtained. After the reaction was completed, the prepolymer was cooled to 40° C., and 96.75 parts of acetone was added to dilute the prepolymer. Thus, a prepolymer solution was obtained. Next, the prepolymer solution thus obtained was poured slowly into an aqueous amine solution obtained by dissolving 7.04 parts of piperazine, 10.19 parts of triethylamine and 245.19 parts of water so that chain extension and neutralization were performed simultaneously. After acetone was removed from the product of this reaction at 50° C. under reduced pressure, water was added. Thus, an aqueous dispersion of a polyester-based ionomer-type urethane resin containing non-volatile components at a concentration of 30% and having a viscosity of 60 mPa·s/25° C. and a pH of 7.1 was obtained. Then, 20 parts of the aqueous dispersion thus obtained and 1.2 parts of self-emulsifiable polyisocyanate were dispersed in 14. 8 parts of deionized water. Thus, an adhesive (D-2) containing non-volatile components at a concentration of 20% was obtained.

### Production Example 5

8000 g of MMA, 2000 g of MHMA, and 10000 g of toluene as a polymerization solvent were charged into a 30-liter reaction vessel equipped with a stirrer, a temperature sensor, a condenser tube, and a nitrogen inlet tube, and the mixture was heated to 105° C. while nitrogen gas was introduced thereinto. When the reflux started as the temperature of the mixture increased, 10.0 g of t-amylperoxyisononanoate was added as a polymerization initiator, and simultaneously a mixed solution of 20.0 g of t-amylperoxyisononanoate and 100 g of toluene was added dropwise over 2 hours so that the mixture was subjected to solution polymerization under reflux at about 105 to 110° C., and then the mixture further was aged for 4 hours. The polymerization reaction rate was 96.6%, and the content (in a weight ratio) of MHMA in the obtained polymer was 20.0%.

Next, 10 g of a stearyl phosphate/distearyl phosphate mixture (Phoslex A-18, manufactured by Sakai Chemical Industry Co., Ltd.) as a cyclization catalyst was added into the polymer solution thus obtained, so that the resulting mixture was subjected to cyclocondensation reaction under reflux at about 80 to 100° C. for 5 hours.

Then, the resulting polymer solution was introduced into a vent type twin-screw extruder (φ=29.75 mm, L/D=30) equipped with one rear vent and four fore vents at a processing rate of 2.0 kg/h in terms of the amount of resin. The extruder had a barrel temperature of 260° C., and its rotation speed was 100 rpm. The barrel was depressurized to 13.3 to 400 hPa (10 to 300 mmHg). Thus, the polymer solution was subjected to cyclocondensation reaction and devolatilization in the extruder. Next, after the devolatilization was completed, the thermally melted resin that remained in the extruder was extruded from the end of the extruder and then pelletized by a pelletizer. Thus, a transparent pellet made of an acrylic resin having a lactone ring structure in its main chain was obtained. This resin had a weight average molecular weight of 148000, a melt flow rate of 11.0 g/10 min (which was measured according to JIS K7120 at a test temperature of 240° C. and under a load of 10 kg, and the melt flow rates also were measured in the same manner in the following Production Examples), and a glass transition temperature of 130° C.

Next, the pellet thus obtained and an AS resin (TOYO AS AS 20 (trade name), manufactured by Toyo Styrene Co., Ltd.) were kneaded using a single screw extruder (φ=30 mm) in a weight ratio of pellet/As resin=90/10. Thus, a transparent pellet (E) having a glass transition temperature of 127° C. was obtained.

Next, the pellet (E) thus obtained was melted and extruded from a coat hanger type T-die with a width of 150 mm using a twin-screw extruder equipped with 20 mm φ screws to obtain a film with a thickness of about 160 μm.

Next, a square sample of 97 mm long on each side was cut out from the obtained film, and then fastened to the chucks of the stretching tester used in Production Example 1. The distance between the chucks was set to 80 mm in both the end-to-end and side-to-side directions. After being pre-heated at 160° C. for 3 minutes, the film was subjected to simultaneous biaxial stretching by a factor of 2.0 in both the end-to-end and side-to-side directions (MD and TD directions) for 1 minute. After being stretched simultaneously biaxially, the film was taken out of the tester quickly and cooled.

The biaxially stretched film thus obtained had a thickness of 40 μm, an in-plane retardation of 2 nm, a thickness direction retardation of 3 nm, a total light transmittance of 92%, a haze of 0.3%, and a glass transition temperature of 127° C.

The in-plane retardation and the thickness-direction retardation are the values per 100 μm film thickness at a wavelength of 589 nm, and were evaluated using a retardation measuring apparatus (KOBRA-WR, manufactured by Oji Scientific Instruments). The total light transmittance was evaluated using a haze meter (NDH-1001DP, manufactured by Nippon Denshoku Industries Co., Ltd.). The retardations and the total light transmittances were measured in the same manner in the following Production Examples. All the retardation values obtained in the following Production Examples were the values per 100 μm film thickness at a wavelength of 589 nm.

### Production Example 6

7950 g of MMA, 1500 g of MHMA, 550 g of styrene (St), and 10000 g of toluene as a polymerization solvent were charged into a 30-liter reaction vessel equipped with a stirrer, a temperature sensor, a condenser tube, and a nitrogen inlet tube, and the mixture was heated to 105° C. while nitrogen gas was introduced thereinto. When the temperature reached 105° C., 12 g of t-amylperoxyisononanoate was added as a polymerization initiator, and simultaneously a mixed solution of 24 g of t-amylperoxyisononanoate and 136 g of toluene was added dropwise over 2 hours so that the mixture was subjected to solution polymerization under reflux at about 105 to 110° C., and then the mixture further was aged for 4 hours.

To the resulting polymer solution, 10 g of octyl phosphate (Phoslex A-8, manufactured by Sakai Chemical Industry Co., Ltd.) was added as a cyclization catalyst so that the resulting mixture was subjected to cyclocondensation reaction under pressure at about 120° C. for 5 hours.

Then, the resulting polymer solution was introduced into a vent type twin-screw extruder (φ=29.75 mm, L/D=30) equipped with one rear vent and four fore vents at a processing rate of 2.0 kg/h in terms of the amount of resin. The extruder had a barrel temperature of 240° C., and its rotation speed was 120 rpm. The barrel was depressurized to 13.3 to 400 hPa (10 to 300 mmHg). Thus, the polymer solution was subjected to devolatilization. During the devolatilization, zinc octoate (Nikka Octhix Zinc, manufactured by Nihon Kagaku Sangyo Co., Ltd.) as a defoaming agent was added from between the second and third fore vents so that the concentration of zinc octoate became 1400 ppm (in terms of weight) with respect to the resin obtained in the form of a toluene solution.

A water bath filled with filtered clean cooling water was placed at the end portion of a twin-screw extruder. A strand extruded from the end portion of the extruder was cooled in the water bath, and then the cooled strand was introduced into a pelletizer. Thus, a transparent pellet (F) made of an acrylic resin having a lactone ring structure in its main chain was obtained. A clean space was provided in the area from the the located at the end of the extruder to the pelletizer so as to achieve the environmental cleanliness level of 5000 or less. The resin thus obtained had a weight average molecular weight of 137000, and a glass transition temperature of 125° C. The number of foreign substances having a particle diameter of at least 20 μm was 35 per 100 g of pellets when observed with an optical microscope.

Next, the pellet (F) thus obtained was melted and extruded from a coat hanger type T-die with a width of 150 mm using a twin-screw extruder equipped with 20 mm φ screws to obtain a film with a thickness of about 160 μm.

Next, a square sample of 97 mm long on each side was cut out from the obtained film, and then fastened to the chucks of the stretching tester used in Production Example 1. The distance between the chucks was set to 80 mm in both the end-to-end and side-to-side directions. After being pre-heated at 155° C. for 3 minutes, the film was subjected to simultaneous biaxial stretching by a factor of 2.0 in both the end-to-end and side-to-side directions (MD and TD directions) for 1 minute. After being stretched simultaneously biaxially, the film was taken out of the tester quickly and cooled.

The biaxially stretched film thus obtained had a thickness of 40 μm, an in-plane retardation of 3 nm, a thickness direction retardation of 2 nm, a total light transmittance of 92%, a haze of 0.4%, and a glass transition temperature of 125° C.

### Production Example 7

5000 g of MMA, 3000 g of MHMA, 2000 g of benzyl methacrylate (BzMA), and 10000 g of toluene as a polymerization solvent were charged into a 30-liter reaction vessel equipped with a stirrer, a temperature sensor, a condenser tube, and a nitrogen inlet tube, and the mixture was heated to 105° C. while nitrogen gas was introduced thereinto. When the reflux started as the temperature increased, 6.0 g of t-amylperoxyisononanoate (Lupasol 570 (trade name), manufactured by Atofina Yoshitomi, Ltd.) was added as a polymerization initiator, and simultaneously a polymerization initiator solution of 12.0 g of t-amylperoxyisononanoate and 100 g of toluene was added dropwise over 6 hours so that the mixture was subjected to solution polymerization under reflux at about 105 to 110° C., and then the mixture further was aged for 2 hours.

Next, 10 g of an octyl phosphate/dioctyl phosphate mixture (Phoslex A-8, manufactured by Sakai Chemical Industry Co., Ltd.) as a cyclization catalyst was added into the polymer solution thus obtained, so that the resulting mixture was subjected to cyclocondensation reaction under reflux at about 80 to 105° C. for 2 hours. The resulting polymer solution was heated in an autoclave under pressure (up to 1.6 MPa in terms of gauge pressure) at 240° C. for 1.5 hour so that the resulting solution was further subjected to cyclocondensation reaction.

Then, the resulting polymer solution was introduced into a vent type twin-screw extruder (φ=29.75 mm, L/D=30) equipped with one rear vent and four fore vents at a processing rate of 2.0 kg/h in terms of the amount of resin. The extruder had a barrel temperature of 250° C., and its rotation speed was 100 rpm. The barrel was depressurized to 13.3 to 400 hPa (10 to 300 mmHg). Thus, the polymer solution was subjected to devolatilization.

Next, after the devolatilization was completed, the thermally melted resin that remained in the extruder was extruded from the end of the extruder and then pelletized by a pelletizer. Thus, a transparent pellet (G) made of an acrylic resin having a lactone ring structure in its main chain was obtained. The resin thus obtained had a weight average molecular weight of 130000, and a glass transition temperature of 135° C.

### Production Example 8

A reaction mixture of 70 parts of deionized water, 0.5 parts of sodium pyrophosphate, 0.2 parts of potassium oleate, 0.005 parts of ferrous sulfate, 0.2 parts of dextrose, 0.1 parts of p-menthanehydroperoxide, and 28 parts of 1,3-butadiene was charged into a pressure vessel type reactor, and the reaction mixture was heated to 65° C., and subjected to polymerization for 2 hours. Next, 0.2 parts of p-hydroperoxide was added to the reaction mixture in the vessel, and 72 parts of 1,3-butadiene, 1.33 parts of potassium oleate, and 75 parts of deionized water were added dropwise continuously over 2 hours. The resulting mixture was allowed to react for 21 hours from the start of polymerization. Thus, a butadiene rubber polymer latex (with an average particle diameter of 0.240 μm) was obtained.

Next, 50 parts of the above-mentioned latex as a solid component, 120 parts of deionized water, 1.5 parts of potassium oleate, and 0.6 parts of sodium formaldehyde sulfoxylate (SFS) were charged into a polymerization vessel equipped with a condenser and a stirrer. The gas inside the polymerization vessel was replaced sufficiently with nitrogen gas. Subsequently, the temperature in the vessel was raised to 70° C. Then, a mixed monomer solution of 36.5 parts of styrene and 13.5 parts of acrylonitrile and a polymerization initiator solution of 0.27 parts of cumene hydroxy peroxide and 20.0 parts of deionized water, separately from each other, were added dropwise continuously over 2 hours so that the mixture was subjected to polymerization reaction. After the dropwise addition of the mixed monomer solution and the polymerization initiator solution was terminated, the temperature in the vessel was raised to 80° C. so that the resulting mixture was subjected to polymerization for another 2 hours. Next, the temperature in the vessel was cooled to 40° C., and then the resulting polymerization solution was filtered through a 300-mesh metal net. Thus, an emulsion polymerization liquid of elastic organic fine particles was obtained.

Next, the obtained emulsion polymerization liquid of elastic organic fine particles was salted out with calcium chloride, solidified, further washed with water, and dried. Thus, powder elastic organic fine particles (P) were obtained. The elastic organic fine particles (P) thus obtained had an average particle diameter of 0.260 μm. The average particle diameter of the elastic organic fine particles was measured with a particle size distribution measuring instrument (Submicron Particle Sizer NICOMP 380) manufactured by NICOMP.

The elastic organic fine particles (P) thus obtained and the pellets (G) obtained in Production Example 7 were fed by a feeder to achieve a weight ratio (P)/(G) of 30/70, and at the same time kneaded at 280° C. using a twin-screw extruder with a cylinder diameter of 20 mm. Thus, a pellet (H) containing elastic organic fine particles was obtained.

Next, the pellet (H) thus obtained was melted and extruded from a coat hanger type T-die with a width of 150 mm using a twin-screw extruder equipped with 20 mm φ screws to produce a film with a thickness of about 140 μm. The unstretched film thus produced had an in-plane retardation of 3 nm.

Next, the unstretched film thus obtained was stretched uniaxially at 136° C. using an Autograph (AGS-100D, manufactured by Shimadzu Corporation). Thus, a uniaxially stretched film having a thickness of 88 μm was obtained. The stretching ratio was 2.5 and the stretching speed was 400%/min. The stretched film thus obtained had an in-plane retardation of 476 nm (419 nm when actually measured), a thickness direction retardation of 246 nm, a total light transmittance of 92%, and a haze of 0.6%.

### Production Example 9

7000 g of MMA, 3000 g of MHMA, and 12000 g of toluene as a polymerization solvent were charged into a 30-liter reaction vessel equipped with a stirrer, a temperature sensor, a condenser tube, and a nitrogen inlet tube, and the mixture was heated to 105° C. while nitrogen gas was introduced thereinto. When the reflux started as the temperature increased, 6.0 g of t-amylperoxyisononanoate (Lupasol 570, manufactured by Atofina Yoshitomi, Ltd.) was added as a polymerization initiator, and simultaneously a mixed solution of 12.0 g of t-amylperoxyisononanoate and 100 g of toluene was added dropwise over 2 hours so that the mixture was subjected to solution polymerization under reflux at about 105 to 110° C., and then the mixture further was aged for 4 hours.

Next, 20 g of an octyl phosphate/dioctyl phosphate mixture (Phoslex A-8 (trade name), manufactured by Sakai Chemical Industry Co., Ltd.) as a cyclization catalyst was added into the polymer solution thus obtained, so that the resulting mixture was subjected to cyclocondensation reaction under reflux at about 80 to 105° C. for 2 hours. Next, 4000 g of methylethyl ketone was added to dilute the mixture, and then the resulting polymer solution was heated in an autoclave under pressure (up to about 2 MPa in terms of gauge pressure) at 240° C. for 1.5 hours so that the resulting solution further was subjected to cyclocondensation reaction.

Next, the obtained polymer solution was diluted with methylethyl ketone, and then the same procedure was carried out as in Production Example 5, except that: (1) a solution of 26.5 g of zinc octoate (18% Nikka Octhix Zinc, manufactured by Nihon Kagaku Sangyo Co., Ltd.), 2.2 g of IRGANOX 1010 (Ciba Speciality Chemicals Inc.) and 2.2 g of ADEKASTAB AO-4125 (manufactured by ADEKA Corporation) as antioxidants, and 61.6 g of toluene as a solvent was introduced at a rate of 20 g/h; and (2) the barrel temperature was changed to 250° C. Thus, a transparent pellet (I) made of an acrylic resin having a lactone ring structure in its main chain was obtained.

The obtained pellet (I) was subjected to dynamic TG measurement, and a 0.21% weight loss was detected. The obtained resin had a weight average molecular weight of 110000, a melt flow rate of 8.7 g/10 min, and a glass transition temperature of 142° C.

Subsequently, the obtained pellet (I) was extruded and molded into an unstretched film (J) with a thickness of about 400 μm, using a single screw extruder with a cylinder diameter of 20 mm under the following extrusion conditions:

Extrusion condition—Cylinder temperature: 280° C.

Die: Coat hanger type, Width of 150 mm, Temperature of 290° C.

Casting: Two glossy rolls, Both first and second rolls maintained at 130° C.

The obtained film (J) was strip-shaped. The width direction of this film is the TD direction, and the direction in which the film is stretched (that is, the direction perpendicular to the TD direction in the plane of the film) is the MD direction.

The unstretched film (J) thus obtained had an in-plane retardation of 0.3 nm (1.3 nm when actually measured), a thickness direction retardation of 0 5 nm (2.2 nm when actually measured), a thickness of 433 μm, and a glass transition temperature of 142° C.

### Production Example 10

The unstretched film (J) produced in Production Example 9 was sequentially biaxially stretched using the stretching tester used in Production Example 1.

Specifically, a square sample of 127 mm long on each side was cut out from the film (J), and then fastened to the chucks of the stretching tester so that the sample was to be stretched in the MD direction. The distance between the chucks was set to 110 mm in both the end-to-end and side-to-side directions. After being pre-heated at 165° C. for 3 minutes, the resin film was subjected to a first stage of uniaxial stretching by a factor of 3.0 for 10 seconds. The first stage of stretching was carried out so that the film did not shrink in the width direction (TD direction) of the film.

After being stretched uniaxially, the resin film was taken out of the tester quickly and cooled. Subsequently, another square sample of 97 mm long on each side was cut out from the film thus cooled, and subjected to a second stage of uniaxial stretching in the same manner as in the first stage of uniaxial stretching. The second stage of stretching was performed in the direction (TD direction) perpendicular to the direction of the first stage of stretching. When the film was placed in the tester, the distance between the chucks was set to 80 mm in both the end-to-end and side-to-side directions. The film was pre-heated at 145° C. for 3 minutes, and then subjected to the second stage of stretching by a factor of 2.2 for 1 minute. The second stage of stretching was carried out so that the film did not shrink in the direction (MD direction) perpendicular to the stretching direction thereof, just as in the case of the first stretching.

The biaxially stretched film thus obtained had an in-plane retardation of 282 nm (135 nm when actually measured), a thickness direction retardation of 307 nm (148 nm when actually measured), a thickness of 48 m, a total light transmittance o 93%, a haze of 0.3% and a glass transition temperature of 142° C.

### Production Example 11

The unstretched film (J) produced in Production Example 9 was sequentially biaxially stretched under the stretching conditions different from those in Production Example 10. Specifically, the film was subjected to the first stage of stretching at a temperature of 150° C. by a factor of 2.5 for 1 minute. The film was subjected to the second stage of stretching at a temperature of 150° C. by a factor of 2.5 for 1 minute.

The biaxially stretched film thus obtained had an in-plane retardation of 142 nm (91 nm when actually measured), a thickness direction retardation of 203 nm (130 nm when actually measured), a thickness of 64 μm, a total light transmittance of 93%, a haze of 0.2% and a glass transition temperature of 142° C.

### Production Example 12

The unstretched film (J) produced in Production Example 9 simultaneously was biaxially stretched under the stretching conditions different from those in

Production Example 10. The film was pre-heated at 155° C. for 3 minutes, and then stretched at a temperature of 155° C. by a factor of 2.5 in both the TD and MD directions for 1 minute.

After being stretched simultaneously biaxially, the resin film was taken out of the tester quickly and cooled. The biaxially stretched film thus obtained had an in-plane retardation of 21 nm (8 nm when actually measured), a thickness direction retardation of 213 nm (81 nm when actually measured), a thickness of 38 μm, a total light transmittance of 93%, a haze of 0.2%, and a glass transition temperature of 142° C.

### Production Examples 13 to 22

The resin films having a thickness of 100 μm formed from the resin compositions produced in Examples 2 and 4 and the resin films produced in Production Examples 1, 5, 6, 8, and 10 to 12 were used as polarizer protective films. Each of these polarizer protective films was laminated to both surfaces of the polarizer produced in Production Example 2 to obtain a polarizing plate. The bonding strength between the polarizer and the polarizer protective film in the polarizing plate thus obtained, and the heat and moisture resistance of the polarizing plate were evaluated.

The polarizing plate was produced in the following manner.

First, using a bar coater, the easily adhesive layer coating composition (D-1) obtained in Production Example 3 was applied to the surface of the polarizer protective film to which the polarizer was to be laminated, and then dried with a hot air dryer at 100° C. Next, the adhesive (D-2) obtained in Production Example 4 was applied to the dried composition (D-1), and then the polarizer was brought into contact with the adhesive (D-2) so as to be laminated to the polarizer protective film. This lamination was performed by wet lamination while the excess adhesive was being removed by a pressure bonding roller. In this case, the surface of the polarizer, to which the polarizer protective film was laminated, was referred to as a “surface A”.

Next, as in the case of the surface A, the easily adhesive layer coating composition (D-1) and the adhesive (D-2) were applied to the surface B of the polarizer opposite to the surface A, and then another polarizer protective film was laminated to the surface B of the polarizer by wet lamination. Next, the polarizer and the polarizer protective films laminated thereto were dried in a hot air dryer at 60° C. for 10 hours, and then dried in an oven at 50° C. for 15 hours. Thus, a polarizing plate having a structure in which a polarizer was sandwiched between a pair of polarizer protective films was obtained. The layer of the adhesive (D-2) had a thickness of 50 μm after being dried. Table 3 shows the types of the polarizer protective films laminated to the respective surfaces A and B in the polarizing plates, and the evaluation results of the bonding strength and the heat and moisture resistance of the polarizing plates thus obtained. The bonding strength and the heat and moisture resistance were evaluated in the following manner.

[Bonding Strength]

Each of the polarizing plates thus produced was fixed to a polypropylene plate with a double-sided adhesive tape, and then the polarizer protective film was tried to be peeled off from the polarizer. The bonding strength between the polarizer and the polarizer protective film was evaluated on the following five-point scales based on the peeling state of the polarizer protective film.

1: The film was peeled off easily when the end portion of the film was pulled with fingers

2: The film was peeled off when the edge of a cutter knife was inserted between the polarizer and the film

3: The film was peeled off when the edge of a cutter knife was inserted between the polarizer and the film and additional force was applied thereto

4: Only small pieces were peeled off partially even when the edge of a cutter knife was inserted between the polarizer and the film

5: The edge of a cutter knife could not be inserted between the polarizer and the film and no peeling occurred

[Heat and Moisture Resistance]

Each of the produced polarizing plates was cut into pieces of 2.5 cm×5 cm, and then immersed in hot water at 60° C. for 4 hours to try to peel off the polarizer protective film from the polarizer. The heat and moisture resistance was evaluated on the following three-point scales based on the peeling state of the polarizer protective film.

Good (∘): No peeling occurred

Acceptable (Δ): Partial peeling occurred

Bad (×): Entirely peeled off

TABLE 3

| | | | | Heat and |
|---|---|---|---|---|
| | Polarizer protective film | | Bonding | moisture |
| | Surface A | Surface B | strength | resistance |
| Production | Example 2 | Example 2 | 5 | Good (∘) |
| Example 13 | | | | |
| Production | Example 4 | Example 4 | 5 | Good (∘) |
| Example 14 | | | | |
| Production | Production | Production | 5 | Good (∘) |
| Example 15 | Example 1 | Example 1 | | |
| Production | Example 4 | Production | 5 | Good (∘) |
| Example 16 | | Example 5 | | |
| Production | Production | Production | 5 | Good (∘) |
| Example 17 | Example 1 | Example 5 | | |
| Production | Production | Production | 5 | Good (∘) |
| Example 18 | Example 1 | Example 6 | | |
| Production | Production | Production | 5 | Good (∘) |
| Example 18 | Example 1 | Example 8 | | |
| Production | Production | Production | 5 | Good (∘) |
| Example 20 | Example 1 | Example 10 | | |
| Production | Production | Production | 5 | Good (∘) |
| Example 21 | Example 1 | Example 11 | | |
| Production | Production | Production | 5 | Good (∘) |
| Example 22 | Example 1 | Example 12 | | |

As shown in Table 3, in all Production Examples, the polarizing plates exhibit excellent bonding strength and heat and moisture resistance. The polarizer protective films laminated to the surfaces A of the polarizers are all the polarizer protective films of the present invention, and the acrylic resin composing each of the films has a ring structure in its main chain. Accordingly, the polarizing plates produced in Production Examples 13 to 22 have high ultraviolet absorbing ability, heat resistance, and optical properties.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

The present invention provides a resin composition containing a thermoplastic acrylic resin and an ultraviolet absorber. This resin composition not only exhibits excellent heat resistance because of its high glass transition temperature of 110° C. or higher, but also suppresses the occurrence of foaming and bleed-out even during the high temperature molding thereof, and thereby reduces problems arising from the evaporation of UVA.

1. A thermoplastic resin composition comprising a thermoplastic acrylic resin and an ultraviolet absorber having a molecular weight of 700 or more, and having a glass transition temperature of 110° C. or higher.

2. The thermoplastic resin composition according to claim 1, wherein the ultraviolet absorber has a hydroxyphenyltriazine skeleton.

3. The thermoplastic resin composition according to claim 2, wherein the ultraviolet absorber has a structure represented by the following formula (1): 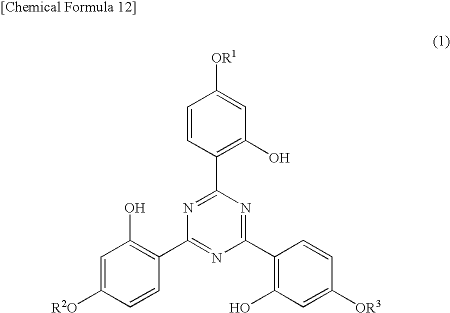
where R¹ to R³ each independently represent a hydrogen atom, or an alkyl group or an alkyl ester group each having 1 to 18 carbon atoms.

4. The thermoplastic resin composition according to claim 1, wherein the acrylic resin has a ring structure in its main chain.

5. The thermoplastic resin composition according to claim 4, wherein the ring structure is at least one selected from a lactone ring structure, a glutaric anhydride structure, a glutarimide structure, an N-substituted maleimide structure, and a maleic anhydride structure.

6. The thermoplastic resin composition according to claim 4, wherein the ring structure is a lactone ring structure.

7. The thermoplastic resin composition according to claim 1, further comprising a copolymer of a cyanated vinyl monomer and an aromatic vinyl monomer.

8. The thermoplastic resin composition according to claim 1, wherein the acrylic resin has a styrene unit as a structural unit.

9. A resin molded article made of the thermoplastic resin composition according to claim 1.

10. The resin molded article according to claim 9, being a sheet or a film.

11. The resin molded article according to claim 9, wherein,
in the case where the resin molded article is a first film having a thickness of 100 μm, the first film has a light transmittance of 1% or less at a wavelength of 380 nm and a light transmittance of 90% or more at a wavelength of 500 nm when the transmittances are measured according to JIS K7361: 1997, and
in the case where the resin molded article is a second film having dimensions of 100 μm thick, 1 cm wide, and 3 cm long, a solution placed in a quartz cell with an optical path length of 1 cm has a light absorbance of less than 0.05 at a wavelength of 350 nm when the absorbance is measured with an absorption spectrometer, the solution being prepared by heating the second film at 150° C. for 10 hours to obtain a volatile component of the second film and dissolving the volatile component in a solvent of 1 ml volume

12. A polarizer protective film made of the thermoplastic resin composition according to claim 1.

13. A polarizing plate comprising a polarizer and the polarizer protective film according to claim 12.

14. An image display apparatus comprising the polarizing plate according to claim 13.

15. A method of producing a resin molded article, comprising the step of extruding the thermoplastic resin according to claim 1 so as to obtain the molded article.
